(19) United States
(12) Patent Application Publication
(10) Pub. No.: US 2002/0061676 A1
(43) Pub. Date: May 23, 2002

(54) Auxiliary device module

(75) Inventors: Isao Kameyama, Shizuoka (JP); Takakazu Takahashi, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 09/987,909

(22) Filed: Nov. 16, 2001

(30) Foreign Application Priority Data
Nov. 17, 2000 (JP) 2000-351819

(51) Int. Cl. H01R 4/24

(52) U.S. Cl. 439/404

(57) ABSTRACT

An auxiliary device module Z includes an auxiliary device 1, a base board 2 mounted on the auxiliary device 1 and provided with terminals 5e and a case 3 in which the base board 2 can be mounted. Fitting the base board 2 into the case 3, the terminals 5e of the base board 2 and electric wires 4 of a connecting portion 5e′ in the case 3 are connected electrically to form a connector 5. Positioning portions 6 for guiding the terminals 5e are provided in the connecting portion 5e′. Thereby, when assembling the auxiliary device module Z, connecting electrically the terminal 5e with the electric wires 4 can be done simultaneously, accurately and easily.

### BACKGROUND OF THE INVENTION

1. Field of the Invention

This invention relates to an auxiliary device module with high manufacturability and high yield by connecting electrically an auxiliary device, such as a car-mount type CCD camera, and a base board mounted on the auxiliary device and a case, on which the auxiliary device and the board can be mounted, by means of a connector.

2. Description of the Related Art

A camera module Y, Z by prior art will be described with reference to FIGS. 19-22. FIG. 19 is a partial expanded view of a wire harness 4 provided with a clamp 10 having an O-ring 11. The O-ring 11 is provided in the clamp 10 to keep a camera case 3 airtight when mounting the clamp 10 on the camera case 3.

The clamp 10 is provided with a thread portion 10a for fixing the clamp securely on a camera case and a hexagon head portion 10b to be used when the clamp 10 is fixed on a camera case by thread fastening and a flange 10c to generate fastening force between the clamp 10 and the camera case 3 and perform keeping the O-ring 11 airtight.

The clamp 10 is provided inside thereof with a through hole 10d to run electric wires or the like, such as cables 4a, 4a′, through. As shown in FIG. 19, electric wires of cables 4a, 4a′ including a drain wire 4a′ run through the through hole 10d of the clamp 10 having the O-ring 11. Terminals 5p are mounted on the end of respective cable 4a, 4a′.

After putting the cables 4a, 4a′ through the through hole 10d of the clamp 10, potting process 12 is done. Describing potting process 12 simply, it is sealing by pouring soft rubber or soft resin such as epoxy polymer in required portion.

Sealing for each cable 4a, 4a′ can be done completely by potting process 12. Then, penetrating of water or dust into inside of a camera case or camera is prevented. Sealing test on a potting processed portion can be done by leakage test on water or air.

FIG. 20 and FIG. 21 are perspective views, showing assembling process of camera modules Y, Z with a car-mount type CCD camera by prior art. A camera module Y with a car-mount type CCD camera by prior art will be described simply here. The camera module Y includes a camera 1 such as a car-mount type CCD camera and a base board 2 mounted with the camera 1. A camera module Z is provided with a camera module Y having a camera 1 and a base board 2, a camera case 3 mounted with the camera module Y and a wire harness 4 formed with bound various cables 4a, 4a′.

FIG. 20 and FIG. 21 show assembling process of a car-mount type CCD camera by prior art. FIG. 21 is a perspective view, showing wrong condition when mounting the camera module Y with the camera 1 and the base board 2 on the camera case 3. FIG. 22 is a conceptual drawing, showing a sectional view taken along the line R-R of FIG. 20, 21 and connection of the wire harness 4, specifically showing a condition of mounting the wire harness 4 on the camera case 3 through the clamp 10 by partially expanded view.

Each part of the camera module Z by prior art shown in FIGS. 20-22 is described in detail. The camera 1 is provided with a lens 1c and a lens area portion id to hold the lens 1c. The base board 2 mounted with the camera 1 includes mainly a base board body 2′ provided with electric elements such as connectors for electrical connecting. The base board body 2′ is provided with a connector housing 2c as a connector related element. The base board body 2′ is also provided at four locations near four corners thereof with screw through holes 2b for fixing the base board 2 on the camera case 3 by fastenings such as screws 13b.

The camera case 3 is formed with a bottom wall 3c and side walls 3d, 3d′ standing around the bottom wall to provide a receiving section 3e. The side wall 3d′ is provided with a cylindrical projection 3g for fixing the clamp 10 and sealing the camera case 3. The camera case 3 is provided on four corners in an inside of the receiving section 3e with screw fixing bodies 3a for fixing the base board 2 mounted with the camera 1 thereon. Each screw fixing body 3a has a tapped hole 3b.

Joint structure of the clamp 10 and the camera case 3 shown in FIG. 20, 21 is described in detail with reference to FIG. 22. The camera case 3 is provided on the side wall 3d′ with a through hole 3f for putting the wire harness 4 formed by bound cables 4a, 4a′ through. The through hole 3f is formed inside wall thereof with internal tread portion to combine with the thread portion 10a of the clamp 10 for fastening.

The clamp 10 with led cables 4a, 4a′ shown in FIG. 19 through is mounted in the through hole 3f formed on the side wall 3d′ of the camera case 3. Combining the thread portion 10a of the clamp 10 and the through hole 3f, formed with thread, of the camera case 3, the clamp 10 with led wire harness 4 shown in FIG. 24 through is fixed on the camera case 3.

The camera case 3 is provided around the through hole 3f with the cylindrical projection 3g for guiding the clamp 10 with the O-ring 11, mentioned above, into the through hole 3f. The cylindrical projection 3g performs shield plate to keep hermetic sealing by the O-ring mounted on the clamp 10 and to prevent penetrating of water or dust from outside.

The wire harness 4, as shown in FIG. 22, connects the camera case 3 and a non-waterproof connector 5r mounted in an inside-of-car V. The drain wire 4a′ branched at a middle portion of the wire harness 4 is provided at the end with a terminal 5s and the terminal 5s is mounted on a frame of a car body B by means of a screw 13c. Thus, the drain wire 4a′ performs earth ground.

Inserting a connector housing 5q joined with the cables 4a, 4a′ into connector housing 2c, as shown in FIGS. 20, 21, builds a connector and connects electrically the cables 4a, 4a′ and the camera 1 such as a car-mount type CCD camera. Thus, the base board 2 with the camera 1, the wire harness 4, the non-waterproof connector 5r mounted in the inside-of-car V, the drain wire 4a′ and the like are respectively connected electrically.

An example of assembling process for a car-mount type CCD camera by prior art will be described in detail as follows. The clamp 10 with the O-ring 11 is mounted on the wire harness 4, shown in FIG. 19. After inserting the wire harness 4 formed by bound cables 4a, 4a′ through the through hole 10d of the clamp 10, the wire harness 4 and the clamps 10 are temporally fixed.

On a portion of the wire harness 4 from the clamp 10 inward the camera case 3, a tube 4d for binding and protecting cables 4a, 4a′ is cleaved by a cutter or the like for pulling the cables 4a, 4a′ out from the tube 4d. The terminals 5p are joined with the end of respective cables 4a, 4a′ and the terminals 5p are received in the connector housing 5q, shown in FIG. 20, to build up connector related elements.

To improve sealing performance of such wire harness 4 and the clamp 10, potting process 12 by pouring resign or rubber into the through hole 10d of the clamp 10 is done and the both of the wire harness and the clamp is fixed, as shown in FIG. 19. The potting process shown in FIGS. 19 and 22 enhances airtight performance of the camera case 3.

Assembling operation of the electric wire 4 and related elements as mentioned above can be called as “assembling of the wire harness 4 and a connector” or more simply “connector assembling”. The clamp 10 is fixed at a suitable position of the wire harness 4 for allowing the cables 4a, 4a′ to have an extra length to connect the camera case 3 with the base board 2, as shown in FIGS. 20 and 21.

The clamp 10, inserting the cables 4a, 4a′ therein, mentioned above, is mounted into the through hole 3f of the camera case 3, as shown in FIG. 22. Thereafter, combining the thread portion 10a of the clamp 10 including the O-ring 11 with the through hole 3f (treaded hole) of the camera case 3, the clamp 10 is fixed on the camera case 3 as shown in FIG. 20 22. The O-ring 11 and potting process 12 give airtight and sealing performance of the camera case 3, as shown in FIG. 22.

After above operation, the camera module Y which is the base board 2 mounted with the camera 1 is set in the camera case 3. The operation process, as shown in FIG. 20, 21, is connecting the connector elements, including the connector housing 5q provided in the wire harness 4, with the connector elements including the connector housing 2c mounted on the base board body 2′.

After connecting connectors or the like mentioned above, the camera module Y is mounted on the camera case 3. Regarding mounting process, the camera module Y provided with the camera 1 and the base board 2 is mounted on the camera case 3 to place the screw through hole 2b provided in the base board 2 correspondingly to the tapped hole 3b provided on the four corners of the camera case 3.

Inserting the screws 13b into each the screw through hole 2b provided in the base board body 2′, the screws are turned by a screw fastening means. Then, the screws 13b go into the tapped holes 3b provided on the camera case 3. Thus, the camera module Y is fixed on the camera case 3 and then the camera module Z is assembled.

When looking related arts, J.U.M. Application Laid-open H7-42075 exists. J.U.M. H7-42075 describes a connector connecting system and discloses a wire alignment and hold mechanism to align automatically respective pair wire without changing coupled order on a connector connecting system to connect automatically respective conductive core wire of a plurality of pair wires into a temporally fixing connector cover.

However, according to a camera module Y by prior art, as shown in FIGS. 20 and 21, operation for connecting the camera module Y and a connector joined with the end of the cable 4a is done manually and then complicated work is required to operators. Furthermore, operations of placing the cables 4a, 4a′ in the receiving section 3e of the camera case 3 and fixing them by the clamp 10 and connecting connectors are poor efficient work.

Describing an actual case, the camera case 3 by prior art is provided with the through hole 3f for inserting the cables 4a, 4a′ therein and the cables 4a, 4a′ with a connector is put through the through hole 3f and the connector is connected with a connector mounted on the base board 2. Such operation is very complicated for operators.

The camera case 3 by prior art is provided with the through hole 3f for inserting the cables 4a, 4a′ and the through hole 3f is threaded. Keeping sealing performance of the through hole 3f, operation of screwing the clamp 10 into the thread portion and fixing the clamp 10 with the wire harness 4 on the camera case 3 is required.

FIG. 21 is a perspective view at a time of bad situation occurred during mounting the camera module Y on the camera case3. During mounting the camera module Y by prior art on the camera case 3, it is feared that the cables 4a, 4a′ are bitten by the camera module Y and the camera case 3 as shown in FIG. 21.

In addition to above issue of biting the cables 4a, 4a′, even if electrical connection is done with a connector provided with pressure contact terminals, the operation for connecting electrically a pressure contact terminal and corresponded electric wire may be done by watching from oblique direction through a gap between the base board 2 and the camera case3 or by blind touch. Such operation requires much attentiveness and load for operators and manufacturability is low. Unsecured pressure contact connection is also concerned.

### SUMMARY OF THE INVENTION

One object of this invention is to provide an auxiliary device module which is miniaturized and reduced on weight by minimizing number of elements provided around the auxiliary device such as a camera, connecting electric wires such as a wire harness and a base board having the auxiliary device such as a camera and terminals such as pressure contact type terminals simultaneously when mounting the base board on a case.

Furthermore, the other object is to overcome the above drawback of biting electric wires such as cables being when mounting the base board provided with an auxiliary device such as a camera on a case, as shown in FIG. 21. Simultaneously, reduction of fraction defective when connecting electrically connectors and speed-up and higher efficiency of assembling operation are the other objects.

Specifically, the object is that a slit of a pressure contact blade provided in a pressure contact type connector abuts on a right position of an electric wire such as a cable or a conductive core wire and contacts it securely. Other object is to provide an auxiliary device module which has no failure of electrical connection caused by deforming a pressure contact blade of a pressure contact type terminal expanded.

In order to attain the objects, according to the invention, there is provided an auxiliary device module including an auxiliary device, a base board provided with the auxiliary device and terminals and a case for mounting the base board thereon. The terminals on the base board and a connecting portion inside the case are electrically connected as a connector by mounting the base board on the case. A positioning portion for the terminals is provided on the connecting portion of the connector.

Since a base board mounted with an auxiliary device and a case are modularized by above means and number of related elements can be reduced, the auxiliary device module is miniaturized and reduced on weight and also assembly structure is simplified. Mounting the base board provided with an auxiliary device and terminals on the case, assembling and electrical connecting can be done simultaneously.

No defective units concerned during assembling by prior art can be realized. On a device by prior art, while mounting the base board provided with an auxiliary device on the case, an electric wire may be bitten by a gap between the base board and the case. Such auxiliary device module with bitten electric wire is judged as a defective unit by concerning open circuit in an electric wire inside.

Abandoning such unfinished products is undesirable for terrestrial environment and wasteful on manufacturing. Then, reassembling such modules to replace elements related with electric wires is required. According to this invention, such defective units can be eliminated without such troublesome operations.

Furthermore, since a connecting portion of the connector formed in the auxiliary device module is provided with a positioning portion for terminals, the terminals are set accurately into required positions of the connector and then electric connection can be done when mounting a base board with the terminals on the case. Thus, operators are not required to pay too much attention for a connector when assembling an auxiliary device module and connecting of connectors assembled by automatic assembling machines is satisfactory. Therefore, speed-up and enhancement on assembling operation can be done and then, a low cost and low fraction defective auxiliary device module can be provided.

An auxiliary device module according to the invention is the auxiliary device module mentioned above, wherein the terminals are pressure contact type terminals, wherein the connecting portion has electric wires, wherein a pressure contact type connector provided with the pressure contact type terminals is mounted on the base board, wherein the case is provided with a connector housing having the electric wires therein, wherein the connector is formed by press-fitting the base board into the case to connect the pressure contact type terminals with the electric wires by pressure, wherein the positioning portion is formed with electric wire setting portions and pressure contact blade receiving grooves, wherein pressure contact connection is done by leading the pressure contact blades into the pressure contact blade receiving grooves.

Thus, operation of electrical connecting can be done easily by pressure contacting connection with pressure contact type terminals. Describing the operation for connecting electric wires with pressure contact type terminals, a pressure contact blade formed on a pressure contact type terminal is pressed on an electric wire such as a cable protected with an insulation cover and a sharp slant portion of the pressure contact type terminal is shearing the cable insulation cover made of resin or rubber and a conductive wire insulation coating such as enamel coating.

Pressing the terminal more, a pressure contact slit formed in the center area of the pressure contact type terminal shears the cable insulating cover more and contacts an inductive wire in the cable. Therefore, stripping the insulating cover and contacting the conductive wire are done simultaneously.

Thus, electrical connecting is given by contacting a U-shape pressure contact slit with an inductive wire in a cable or in an enamel coated wire. In short, electrical connection is given by pressing a pressure contact blade on a required portion of a covered inductive wire of a cable or an enamel coated wire. Since operation of assembling a base board, with an auxiliary device and a pressure contact type connector mentioned above, and a case and operation of pressure contacting connection mentioned above can be done together and simultaneously, electrical connection can be done by assembling a base board provided with an auxiliary device and a case.

Regarding an auxiliary device module by prior art, operation of connecting a pressure contact type terminal with an electric wire requires to pay much attention. An auxiliary device module failed in continuity test after operating pressure contact connection must be treated as a defective product.

If pressure contact connection is applied again on the same position of the electric wire which had be sheared once by a pressure contact type terminal, the second electrical disconnection on the position is concerned. Therefore, an electric wire applied pressure contact connection must be replaced or the other position of the electric wire instead of the position applied pressure contact connection previously may be connected with a pressure contact type terminal.

However, in a module according to this invention, an auxiliary device module is provided in the positioning portion with pressure contact blade receiving grooves for guiding pressure contact type terminals into the connector and then, when mounting a base board mounted with the pressure contact type terminals on a case, electrical connection can be done by guiding securely the pressure contact type terminals on the electric wires in a connector housing. Therefore, failed products mentioned above can be reduced and product yield can be improved.

Describing in detail, since a connector housing is provided in positioning portions with pressure contact blade receiving grooves for leading pressure contact type terminals and pressure contact connection is done by leading pressure contact type terminals into pressure contact blade receiving grooves, the slits of the pressure contact type terminals are successfully led to contact with electric wires such as cables provided in the connector when fitting the base board provided with the pressure contact type terminals into the case. The pressure contact blades of the pressure contact type terminals dig into electric wires such as cables with guide of pressure contact blade receiving grooves. Therefore, the pressure contact blades may not be expanded easily and electrically connecting can be done securely.

An auxiliary device module according to the invention is the auxiliary device module mentioned above, wherein a pair of the pressure contact blades formed in the pressure contact type terminal is guided by corner edges of the pressure contact blade receiving groove inwardly.

Applying such means on the auxiliary device module, a pair of the pressure contact blades formed in the pressure contact type terminal are guided by corner edges of the pressure contact blade receiving grooves and a pair of the pressure contact blades of the pressure contact type terminal are guided inwardly, when the pressure contact type terminals are connected with electric wires and a pair of the pressure contact blades of the pressure contact type terminal may be expanded outwardly.

If a pair of the pressure contact blades of the pressure contact type terminal may be expanded markedly when pressure contact connecting the pressure contact type terminals with electric wires, deformation of the pressure contact blades of pressure contact type terminals is concerned. When the pressure contact blades of pressure contact type terminals are deformed, pressure contact type terminals and electric wires may not be connected securely. However, according to this invention, a pair of the pressure contact blades of the pressure contact type terminal are guided inwardly by the corner edges of the pressure contact blade receiving grooves and then above failure can be prevented.

An auxiliary device module according to the invention is the auxiliary device module mentioned above, wherein a camera module is built with a car-mount type camera as said auxiliary device.

Applying the auxiliary device module according the invention for camera module mounted in a car, number of elements related with the camera module can be reduced and then, the camera module mounted in a car can be miniaturized and the weight and the cost also can be reduced.

Assembling structure of a camera, a base board and a case for a car is simplified. Using pressure contact type terminals, the structure differs from a current camera module in which a crimp contact type terminal is joined with a cable and connected with a connector for a board and electrical connection is done by a pressure contact type connector and then inspection, disassemble and repair can be done easily and also the camera module having good recyclability can be provided. The above and other objects and features of this invention will become more apparent from the following description taken in conjunction with the accompanying drawings.

### BRIEF DESCRIPTION OF THE DRAWINGS

FIG. 1 is an exploded perspective view of one embodiment of an auxiliary device module according to the invention;

FIG. 2 is a conceptual drawing to show a top view of a case shown in FIG. 1 and connection of electric wires;

FIG. 3 is an expanded view of a pressure contact type connector shown in FIGS. 1 and 2;

FIG. 4 is a sectional view taken along the line P-P of FIG. 1 showing the connecting case and the connecting case cover;

FIG. 5 is a partial expanded perspective view of a pressure contact type connector shown in FIG. 1;

FIG. 6 is an expanded view, showing starting process for connecting the pressure contact type terminal with the cable shown in FIGS. 1-3 and 5;

FIG. 7 is an expanded view, showing process after starting for connecting the pressure contact type terminal with the cable shown in FIG. 6;

FIG. 8 is an expanded view, showing finished condition for connecting the pressure contact type terminal with the cable shown in FIG. 7;

FIG. 9 is an expanded perspective view of other example of a pressure contact type connector shown in FIG. 1;

FIG. 10 is an expanded view, showing starting process for connecting the pressure contact type terminal with the cable shown in FIGS. 1-3 and 9;

FIG. 11 an expanded view, showing process after starting for connecting the pressure contact type terminal with the cable shown in FIG. 10;

FIG. 12 is an expanded view, showing finished condition for connecting the pressure contact type terminal with the cable shown in FIG. 11;

FIG. 13 is an explanatory drawing of other example of a pressure contact type terminal and a positioning portion shown in FIG. 6;

FIG. 14 is an explanatory drawing of other example of a pressure contact type terminal and a positioning portion shown in FIG. 10;

FIG. 15 is an expanded perspective view of other example of a pressure contact type connector shown in FIG. 1;

FIG. 16 is an expanded view, showing starting process for connecting the pressure contact type terminal with the cable, shown in FIG. 15;

FIG. 17 is an expanded view, showing process after starting for connecting the pressure contact type terminal with the cable, shown in FIG. 16;

FIG. 18 is an expanded view, showing finished condition for connecting the pressure contact type terminal with the cable, shown in FIG. 17;

FIG. 19 is a partial expanded view of a wire harness mounted with a clamp having an O-ring;

FIG. 20 is a perspective views, showing assembling process of camera modules by prior art;

FIG. 21 is a perspective views, showing a trouble condition when fitting a camera module in a camera case by prior art; and

FIG. 22 is a conceptual drawing, showing a partial expanded sectional view taking along the line R2-R2 of FIG. 20, 21 and condition of connecting the wire harness.

### DESCRIPTION OF THE PREFERRED EMBODIMENTS

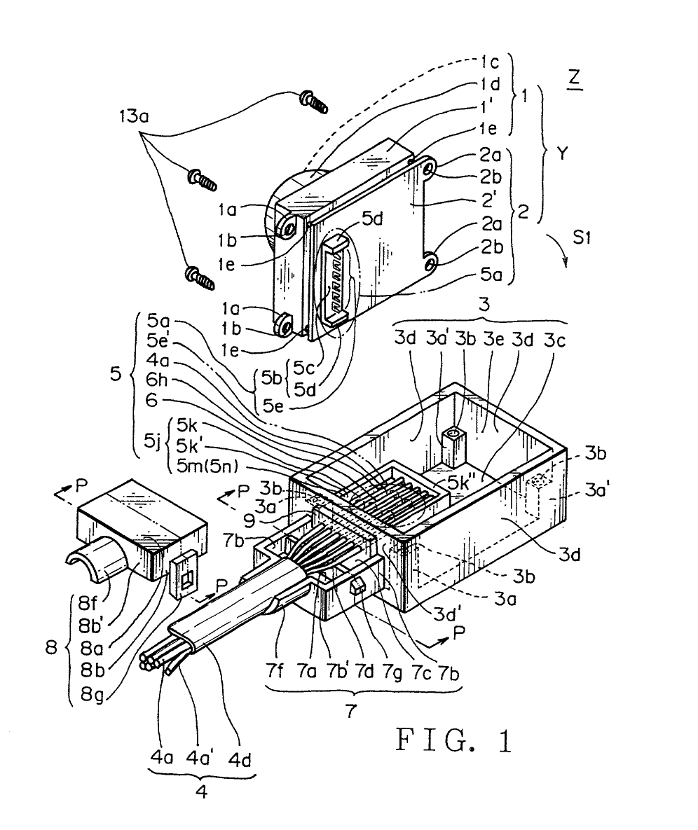

A camera module Z as an embodiment of an auxiliary device module according to this invention will now be described with reference to FIGS. 1-18. The same named elements as respective elements in the example by prior art, mentioned above, are put with the same number and the detailed description on the structure is omitted.

Regarding definition of upper-and-lower and front-and-rear direction in FIG. 1, a side of a lens 1c in an assembled camera module Z is the upper side and a side of a bottom wall 3c in a camera case 3 is the lower side. A direction of an electric wire 4, such as a wire harness 4, extending from the camera case 3 is the front side or this side and the opposite direction is the rear side or the back side.

Assembly provided with at least two elements like an auxiliary device 1 such as a camera 1 having a base board 2 is defined as an auxiliary device module Y and specifically is called a camera module Y. Assembly provided with at least three elements like an auxiliary device 1 such as a camera 1 and a base board 2 mounted on the auxiliary device 1 such as the camera 1 and the camera case 3, on which such base board 2 is mounted, is defined as an auxiliary device module Z and specifically is called a camera module Z. In this invention, the camera modules Y or Z can be called a crowned body.

A connector in this invention is defined as a member provided with electrical connecting elements, like a connector housing, terminals, a terminal portion and an electric wire, for electrical connecting. A connector according to this invention may be additionally provided with a packing, a rubber plug or a rear holder. Regarding a connector, a connector provided with male terminals is called a male connector in general and a connector provided with female terminals is called a female connector. However, in this invention, a member provided with at least a terminal and a connector housing is called a connector.

An electric wire 4 in this invention gives a generic name to a wire harness 4, a cable 4a or a core wire including a drain wire 4a′, or a conductive wire 4b without coating. Describing the cable 4a or 4a′ in this invention, the cable 4a or 4a′ is called core wire and is formed with one inductive wire 4b or a plurality of the inductive wires 4b coated by a insulation cover 4c or enamel material.

A CCD camera or a MOS (Metal Oxide Semiconductor) camera or any kind of camera can be used for a camera in this invention.

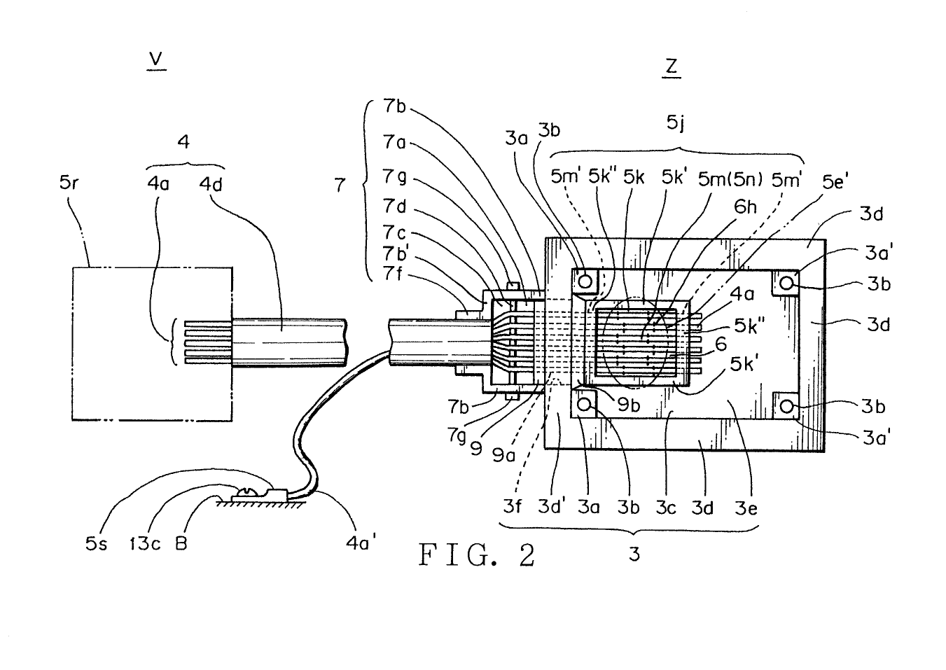

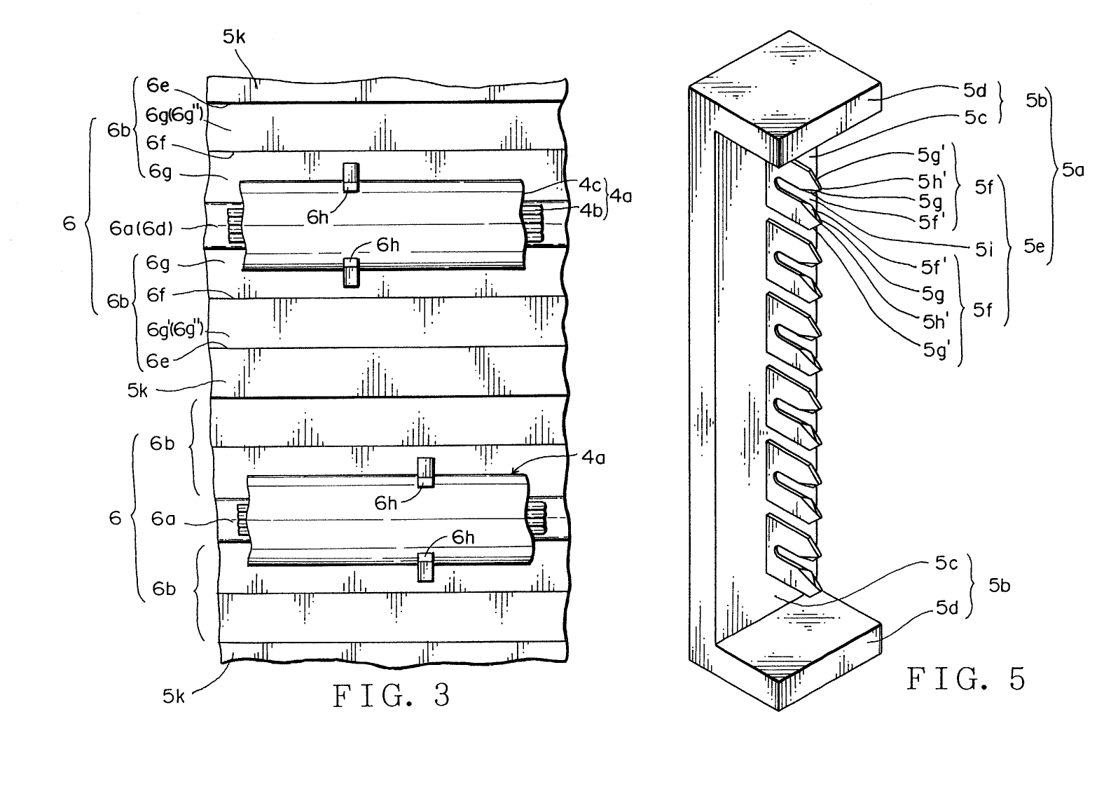

Outline of assembling operation for a camera module Z will be described with reference to FIGS. 1 and 2. Expanded some specific area in FIGS. 1, 2 will be described with reference to FIGS. 3-8. Example of assembling operation for the other camera module Z will be described with reference to FIGS. 9-18.

FIG. 1 is an exploded perspective view of one embodiment of an auxiliary device module Z according to the invention, showing a camera module Z as the auxiliary device module Z. FIG. 2 is a conceptual drawing to show a top view of a camera case 3 shown in FIG. 1 and connection of a wire harness 4, showing minutely a inside of a connector housing 5j shown in FIG. 1 and relative portions.

FIG. 3 is an expanded conceptual drawing of a connecting portion 5e′ in a surround area of a connector housing 5j formed in a receiving section 3e of a camera case 3 shown in FIGS. 1 and 2. Describing specifically, FIG. 3 is an expanded conceptual drawing of a inside of the connecting portion 5e′ shown in a top view of the camera case 3 in FIG. 2.

FIG. 1 shows a condition of mounting a camera module Y, formed with a camera 1 including CCD with a base board 2, and a connecting case cover 8 on a specific position of the camera case 3. The camera module Z, as shown in FIG. 1, is provided at least with a camera 1 including CCD, a base board 2 having the camera 1 and a terminals 5e, i.e. a camera module Y and a camera case 3 for mounting the camera module Y including the base board 2 with the camera 1 thereto.

Putting the base board 2 into the camera case 3 along mount direction S1, the terminal 5e on the base board 2 and a connecting portion 5e′ in the camera case 3 form a connector 5 and the terminal 5e and the connecting portion 5e′ are electrically connected. The connector 5, as shown in FIG. 1 3, is provided juxtapositionaly in parallel and at even intervals in the connecting portion 5e′ with positioning portions 6 corresponding to the terminal Se.

Thereby, the camera 1, the base board 2 and the camera case 3 are modularized and then number of related elements can be reduced and miniaturization, weight saving and structural simplification of the module can be done. Furthermore, mounting the base board 2 provided with the camera 1 and the terminal 5e on the camera case 3 can perform assembling operation and electrically connecting operation simultaneously.

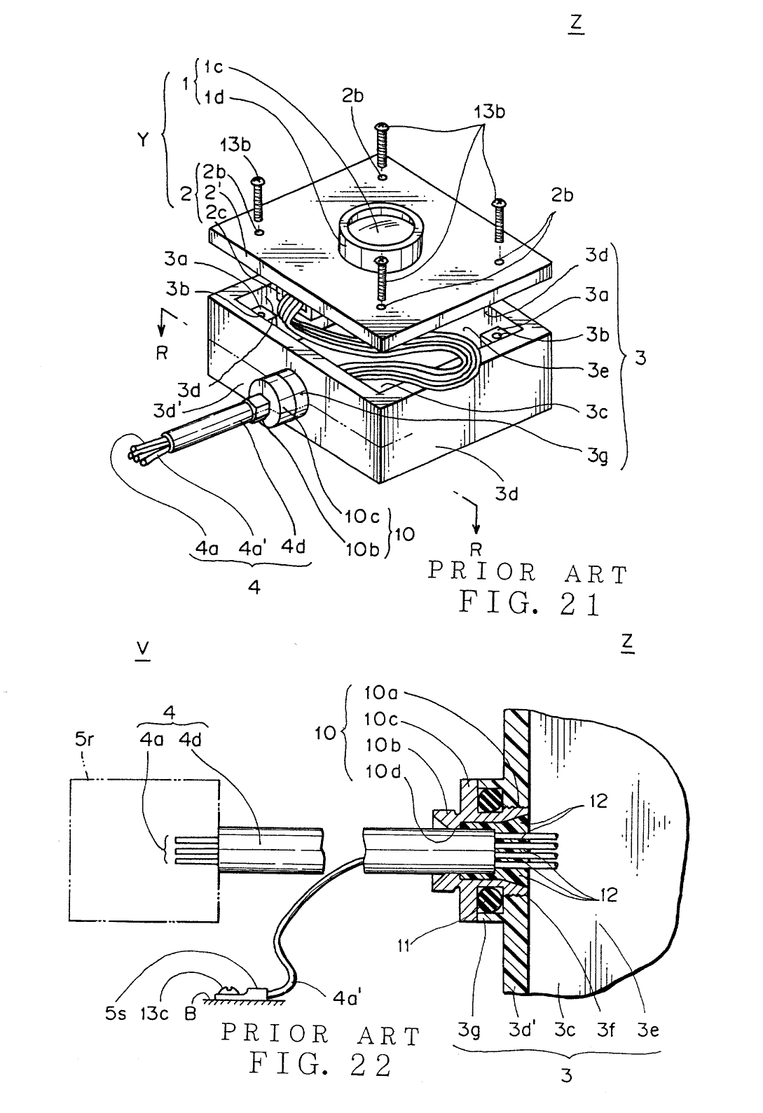

Defective units concerned while assembling a camera module Z by prior art, shown in FIG. 21, can be eliminated. According to prior art, during mounting a base board 2 including a camera 1 on a camera case 3, it is feared that a cable 4a and a drain wire 4a′ are bitten by the base board 2 and the camera case 3 and such camera module Z with bitten electric wire is judged as a defective unit by concerning open circuit in the inside of the cable 4a and the drain wire 4a′.

Abandoning such unfinished products is undesirable for terrestrial environment and wasteful on manufacturing. Then, reassembling a camera module Z to replace the wire harness 4 formed with the cable 4a, the drain wire 4a′ and a tube 4d, a clamp 10 and other elements related with an electric wire 4 is required. According to this invention, such defective units can be eliminated without such troublesome operations.

Since the connector 5 formed in the camera module Z, as shown in FIGS. 1 and 3, is provided juxtapositionaly in parallel and at even intervals in the connecting portion 5e′ with positioning portions 6 for connecting satisfactorily the terminals 5e with the connecting portion 5e′, the terminals 5e is received accurately to the connecting portion 5e′, shown in FIG. 2, when mounting the base board 2 including the terminals 5e on the camera case 3. Thereby, electrical connection can be done easily and securely.

Thus, operators are not required to pay over attention on a connector 5 when assembling a camera module Z and connecting of a connector 5 assembled by automatic assembling machines is satisfactory. Therefore, speed-up and enhancement on assembling operation can be done and then, a low cost and low percent defective camera module Z can be provided.

Describing minutely respective portion, shown in FIG. 1, the camera 1 is provided with a camera body 1′ including CCD, a screw fixing portion 1a, a screw through hole 1b, a lens 1c, a lens area portion 1d and an other area including positioning holes 1e. Each positioning hole 1e on the camera body 1′ is provided on each four corner of the camera body 1′ to position precisely and fix the camera body 1′ and a base board body 2′. Four positioning projections corresponding to each positioning hole 1e are provided on a bottom surface of the base board body 2′, as shown in FIG. 1.

The base board 2 is provided on a bottom surface with the pressure contact type connector 5a having the connector housing 5b and the pressure contact type terminals 5e. The connector housing 5b is formed with a top wall 5c and a pair of guide portions 5d provided on the both side ends of the top wall 5c. A pressure contact type connector 5a is mounted on a required position of the base board body 2′ to form into a part of the base board 2.

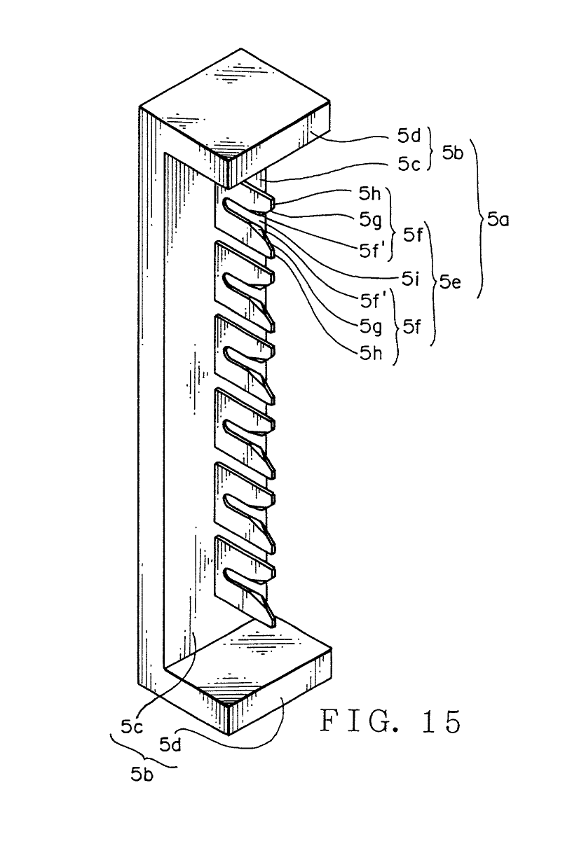

A shape of the pressure contact type terminal and assembling process for connecting the pressure contact type terminal with the cables 4a, 4a′ will be described with reference to FIGS. 15-18. FIG. 15 is an expanded perspective view of the pressure contact type connector 5a shown in FIG. 1. The pressure contact type connector 5a is provided mainly with the pressure contact type terminals 5e having the pressure contact blade 5f and the connector housing 5b. The pressure contact type connector 5a is integrated into the base board 2 and the pressure contact type terminals 5e are connected with various circuits on the base board body 2′.

Six pressure contact type terminals 5e are provided in parallel and at even intervals and in a row on the top wall 5c of the pressure contact type connector 5a. A guide portion 5d of the connector housing 5b is for a guide when the pressure contact type connector 5a is assembled with the connector housing 5j provided in the receiving section 3e of the camera case 3.

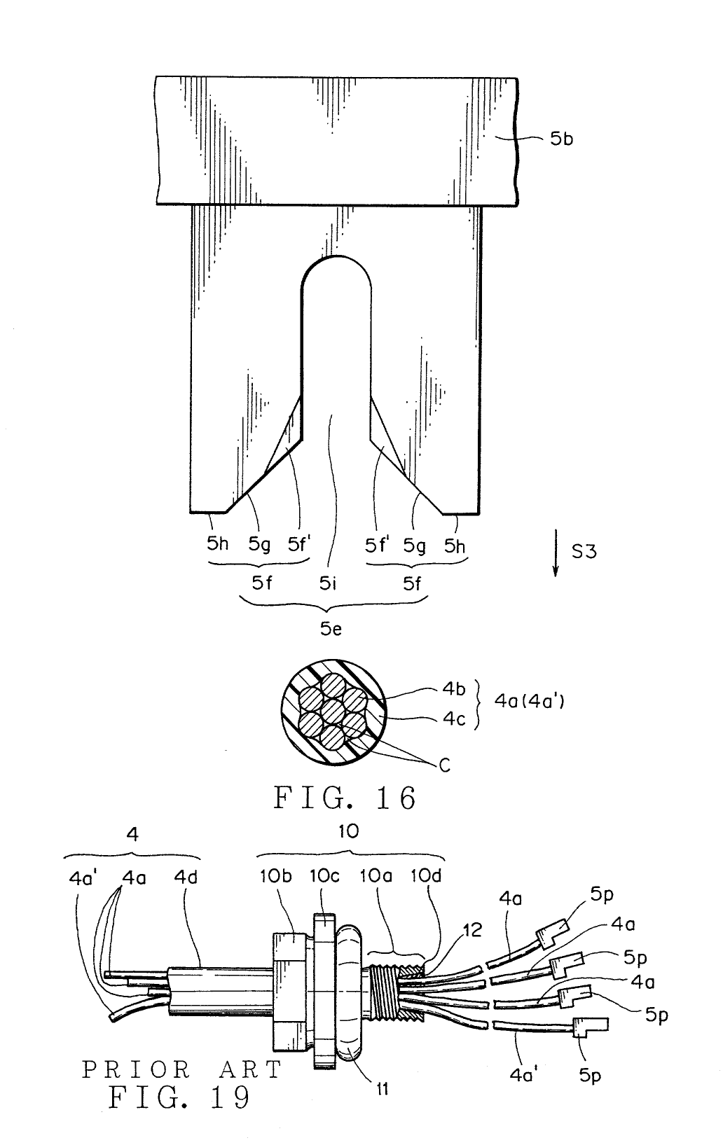

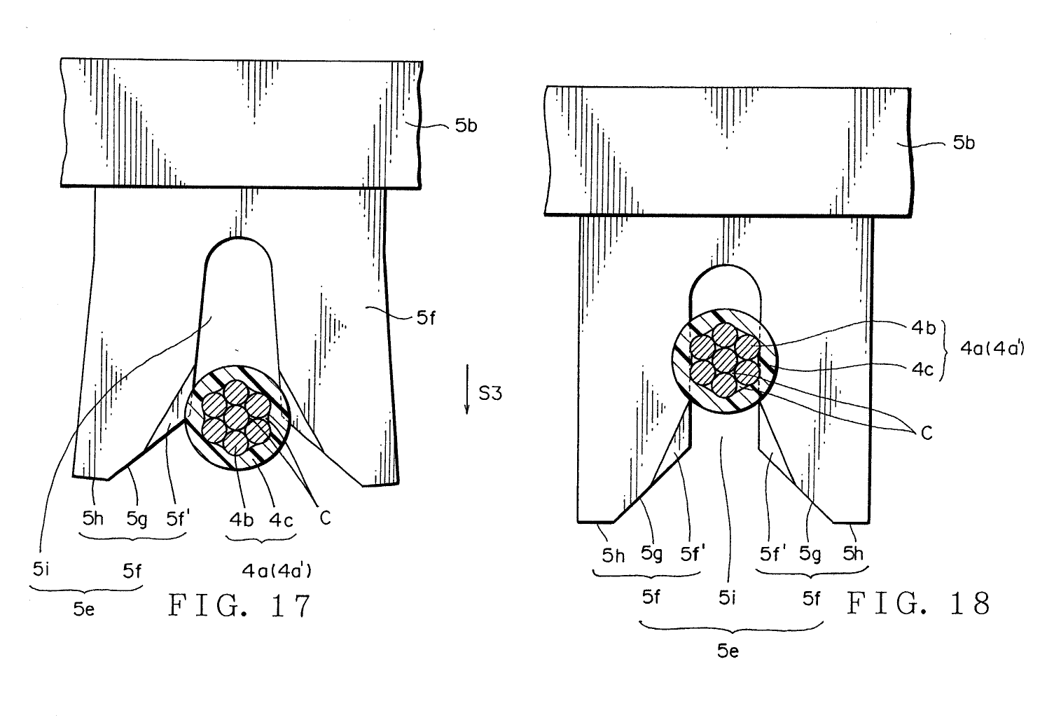

FIG. 16 is an expanded view, showing starting process for connecting the pressure contact type terminal 5e of the pressure contact type connector 5a shown in FIG. 15 with the cable 4a, 4a′. FIG. 17 is an expanded view, showing process after starting for connecting the pressure contact type terminal 5e with the cable 4a, 4a′ shown in FIG. 16, along a mounting direction S3. FIG. 18 is an expanded view, showing finished condition for connecting the pressure contact type terminal 5e with the cable 4a, 4a′ shown in FIG. 17.

Describing a shape of the pressure contact type terminal Se with reference to FIGS. 15 and 16, two slant portions 5g are formed to face each other and two pressure contact blades 5f are aligned in parallel to form the pressure contact type terminal Se. The pressure contact blade 5f is formed in an opening area of inserting cables 4a, 4a′ with a pair of slant portions 5g provided with blade portions 5f′ having oblique sharp-edged shape. The blade portion 5f′ is formed to decrease gradually its thickness of the pressure contact type terminal 5e.

The pressure contact type terminal 5e is formed in the center area with the pressure contact slit 5i dimensioned narrower than diameters of the cables 4a, 4a′ to receive the conductive wires 4b of the cables 4a, 4a′ and wider not to dig into the bundled conductive wires 4b over requirement or cut a circuit. The pressure contact slit 5i is formed into U-shape. The shape of the pressure contact type terminal as mentioned above is a general shape. However, in this invention, other shape may be effective.

The pressure contact type terminal 5e is formed with an edge portion 5h to prevent an operator hand hurt by a sharp edge of the pressure contact slit 5f when assembling the camera module Y by combining the camera 1 and the base board 2 or fitting the camera module Y into the camera case 3. However, the edge portion 5h may be formed into sharp edge shape depending on pressure contact terminal size or shape or place in use.

The pressure contact type terminal 5e is used to connect electrically with the conductive wire 4b as a core wire protected with the insulation cover 4c made of resin, rubber, mixture with them or enamel. Pressure contacting the cables 4a, 4a′, formed with a plurality of conductive wires 4b protected with the insulation cover 4c, with the pressure contact type terminal 5e, shearing the insulation cover 4c and contacting the conductive wire 4b are done simultaneously.

The cables 4a, 4a′, as shown in FIGS. 16-18, are formed with a plurality of conductive wires 4b having small gaps C between them and insulation covers 4c. Soft resin or rubber may be used for materials for the insulation cover 4c or the tube 4d of the electric wire 4 such as cables 4a, 4a′, shown in FIGS. 1, 2, 16-18, used in this invention. The electric wire 4 such as a wire harness 4 is provided with the cables 4a, 4a′, formed with conductive wires 4b and insulation cover 4c, and the tube 4d. The electric wire 4 is bent at any required position in use.

Therefore, a metallic wire having good conductivity and durability for repeat bending is preferable for conducting wire 4b material. In this invention, the core wire made of bundled and temperately twisted plural conductive wires 4b is good on strength. For improving surface insulation of the conductive wires 4b made with metallic wires, enamel coated conductive wires 4b may be used for the electric wire 4 such as the wire harness 4.

Insulation material having durability for repeat bending, as mentioned above, is preferable for insulation cover 4c to protect the conductive wire 4b. For such material, synthetic resin, soft resin, rubber or mixture with them may be used for the insulation cover 4c of the electric wire 4 such as the harness 4.

Describing minutely action of pressure contact connecting the conductive wire 4b through the pressure contact blade 5f of pressure contact type terminal 5e, shown in FIG. 16, to the pressure contact slit 5i of the pressure contact type terminal 5e with reference to FIGS. 17 and 18. Pressure contact connecting starts to press the pressure contact type terminal 5e down to the cables 4a, 4a′ along a mounting direction S3, as shown in FIG. 16. Describing specifically, pressure contact connecting starts to arrange surfaces of a pair of the pressure contact blades 5f forming into the pressure contact type terminal 5e perpendicularly to an extending direction of electric wires 4a, 4a′, i.e. the length direction of electric wires 4a, 4a′ such as the cables 4a, 4a′.

The pressure contact blades 5f formed on the pressure contact terminal 5e starts to press the cables 4a, 4a′ protected with the insulation cover 4c. The insulation cover 4c, made of resin or rubber or the like, of the cables 4a, 4a′ and the insulation cover 4c, made of enamel, coated with thin thickness around the conductive wire 4b are sheared by sharp slant portions 5g i.e. blade portion 5f′ of the pressure contact type terminal 5e. In the process, a pair of the pressure contact blades 5f forming into the pressure contact type terminal 5e are extended outwardly and the pressure contact slit 5i is slightly spread.

Pressing the terminal more, the pressure contact slit 5i, formed in the center area of the pressure contact type terminal 5e, contacts with the internal conductive wire 4b of the cables 4a, 4a′, shearing more the insulation cover 4c, as shown in FIG. 18. Therefore, shearing the insulation cover 4c and contacting the conductive wire 4b are done simultaneously by the pressure contact type terminal 5e.

Thus, contacting the U-shape pressure contact slit 5i, provided with the pressure contact blade 5f, with the internal conductive wire 4b of the cables 4a, 4a′ or the enamel coated conductive wire 4b can give electrically connecting condition. In other words, pressure contacting the pressure contact blade 5f of the pressure contact type terminal 5e with the conductive wire 4b of the cables 4a, 4a′ or the enamel coated conductive wire 4b enables electrical connection.

Since operation of assembling the base board 2, mounted with the camera 1 and the pressure contact type connector 5a, i.e. the camera module Y and the camera case 3 and operation of pressure contact connecting as mentioned above can be done simultaneously, electrical connecting can be done by assembling the base board 2,provided with the camera 1 and the pressure contact type connector 5a, and the camera case 3.

When a pair of the pressure contact blades 5f is spread markedly more than the condition shown in FIG. 17, the pressure contact blades 5f of the pressure contact type terminals 5e are plastically deformed in spread condition and required pressure contact connection as shown in FIG. 18 may not be expected.

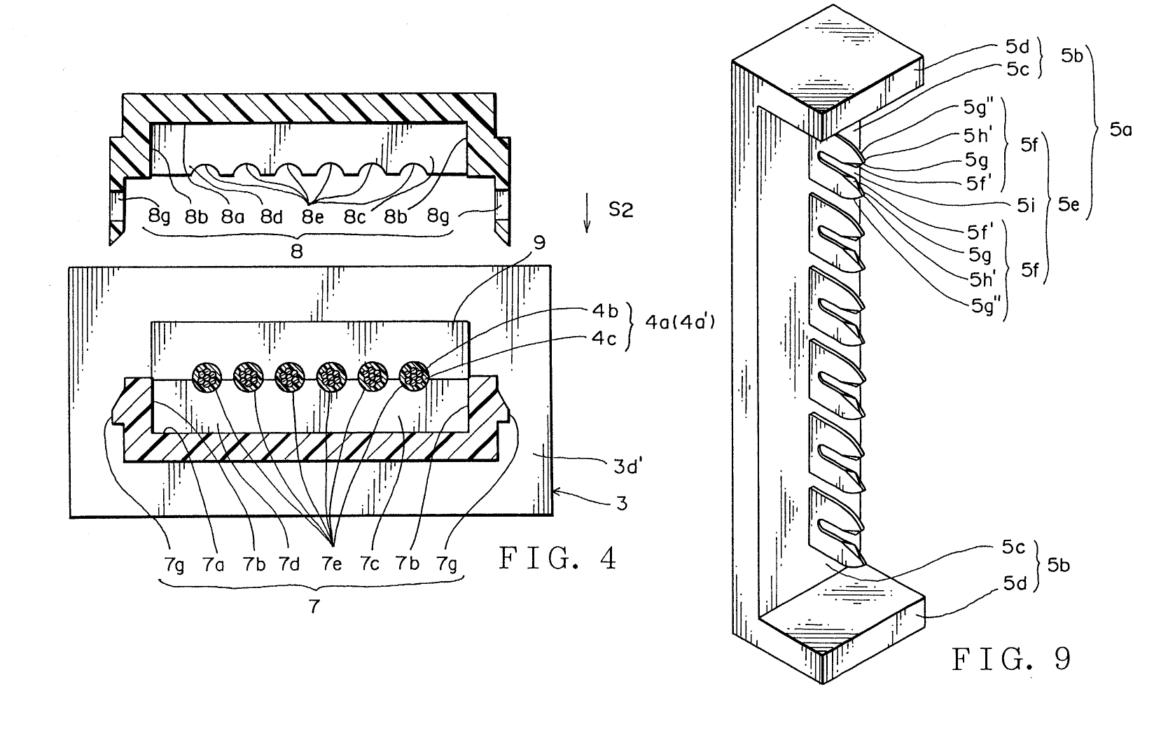

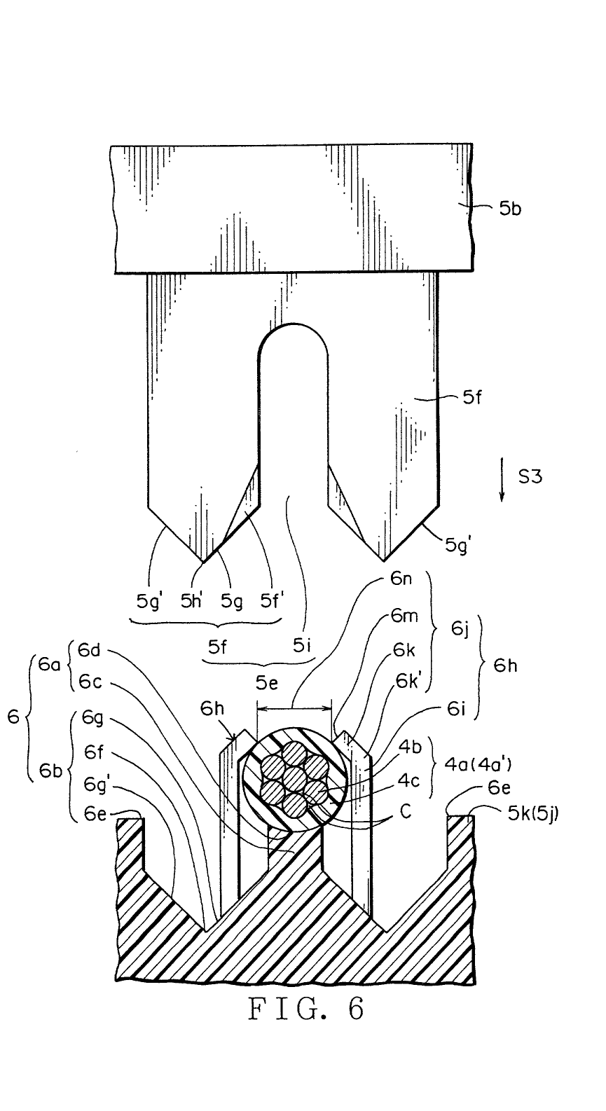

Preventing such failures, pressure contact blade receiving grooves 6b having corners edge 6e are provided on a bottom wall 5k of the connector housing 5j, as shown in FIGS. 6-8, 10 14, to guide the pressure contact blades 5f of the pressure contact type terminals 5e. Shapes of the pressure contact blade receiving grooves 6b or the positioning portions 6 for electric wire setting portion 6a or the pressure contact type terminals 5e corresponding to the pressure contact blade receiving grooves 6b and a process of connecting the pressure contact type terminals 5e and the cables 4a, 4a′ will be described with reference to FIGS. 5-14.

FIG. 5 is an expanded perspective view of a pressure contact type connector 5a mounted on the base board 2 having the camera 1 i.e. the camera module Y shown in FIG. 1. Description on the shape of the pressure contact type connector 5a is almost same as description mentioned above in FIG. 15 and then omitted herein.

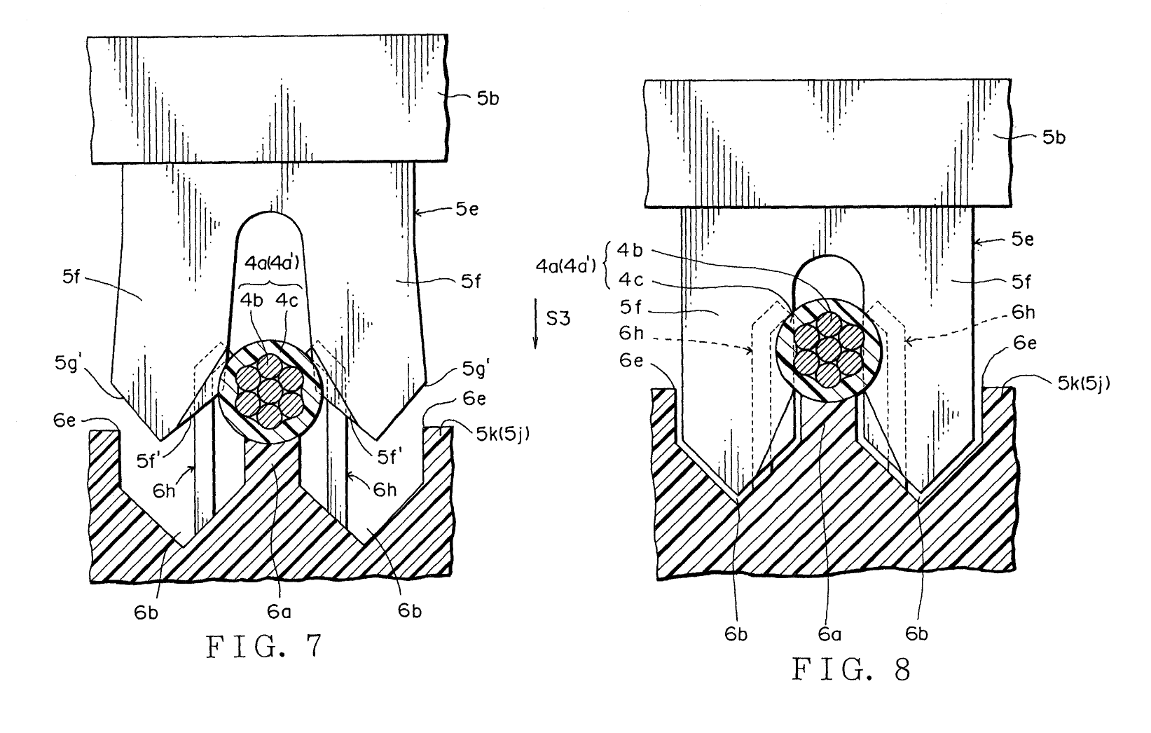

FIG. 6 is an expanded view, showing starting process for connecting the pressure contact type terminals 5e with the cable 4a, 4a′ shown in FIGS. 1-3 and 5. FIG. 7 is an expanded view, showing process after starting connection of the pressure contact type terminal 5e and the cable 4a, 4a′ along a mounting direction S3 shown in FIG. 6. FIG. 8 is an expanded view, showing finished condition of connecting the pressure contact type terminal 5e with the cable 4a, shown in FIG. 7.

A shape of the pressure contact type terminal 5e shown in FIGS. 5-8 and action of connecting the pressure contact type terminal 5e with the cables 4a, 4a′ are almost same as description mentioned above in FIGS. 15-18 and then detailed description on common area will be omitted herein. Differences between the pressure contact type terminals 5e shown in FIG. 15, 16 and the terminals 5e shown in FIGS. 5, 6 will be described as following.

The pressure contact type terminal 5e is formed with a pair of pressure contact blades 5f and a pressure contact slit 5i located between a pair of the pressure contact blades 5f. The pressure contact blades 5f includes two slant portions 5g, 5g′, top portions 5h′ formed by the two slant portions 5g, 5g′ and blade portions 5f′ formed on the slant portions 5g in a side of the pressure contact slit 5i.

The pressure contact type terminal 5e is provided with the slant portions 5g for leading easily the cables 4a, 4a′ into the pressure contact slit 5i of the pressure contact type terminal 5e. Other pair of the slant portions 5g′ are provided outside a pair of the slant portions 5g. Other pair of the slant portions 5g′ are formed to taper off from an outside of the pressure contact type terminal Se. Thus, top edges of the top portions 5h′ of the pressure contact type terminal Se are formed into V-shape.

The slant portions 5g′ are formed to have opposite directions against the direction of the slant portions 5g formed on the pressure contact slit 5i of the pressure contact type terminal 5e to lead the cables 4a, 4a′. Thus, the top portions 5h′ are formed on the pressure contact blades 5f of the pressure contact type terminal 5e by respective pair of the slant portions 5g, 5g′. Forming a pair of the slant portions 5g′ outside the pressure contact type terminal 5e to be narrower, a pair of the pressure contact blades 5f of the pressure contact type terminal 5e is received into the pressure contact blade receiving groove 6b through the corners edges 6e of a pair of the pressure contact blade receiving grooves when connecting.

The positioning portion 6 is formed with the electric wire setting portions 6a provided on the bottom wall 5k of the connector housing as shown in FIGS. 3, 6 and a pair of the pressure contact blades 6b provided at divided positions on the center of the electric wire setting portion 6a. The pressure contact blade receiving groove 6b is formed into a similar shape to the outline of the top portions 5h′ of the corresponding pressure contact type terminal 5e, as shown in FIG. 6. Forming the pressure contact blade receiving groove 6b into a similar shape to the outline of the top portions 5h′ of the pressure contact type terminal 5e, the pressure contact type terminal 5e is received satisfactory into the pressure contact blade receiving groove 6b with no positioning error when connecting.

The electric wire setting portion 6a, as shown in FIG. 6, is provided with a pillar portion 6c and a supporting portion 6d. The supporting portion is formed into in-curved shape correspondingly to an outer surface of the cables 4a, 4a′ to mount the cables 4a, 4a′. The in-curved surface has almost same radius of curvature as the cables 4a, 4a′. The cables 4a, 4a′ formed with a plural of the conductive wires 4a, protected with the insulation cover 4c, are mounted on the supporting portions 6d with in-curved surface.

The pressure contact blade receiving groove 6b, as shown in FIGS. 3 and 6, is formed with corner edges 6e, a groove bottom portion 6f and slant portions 6g, 6g′. The pressure contact blade groove 6b will be described minutely with reference to FIG. 6. The pressure contact blade receiving groove 6b is provided with a vertical surface going down through the corner edge 6e from the surface of the bottom wall 5k of the connector housing, a side wall of the pillar portion 6c of the electric wire setting portion 6a parallel to the vertical surface, two slant portions 6g, 6g′ formed into V-shape slanting from the vertical surface and the side surface of the pillar portion 6c and the groove bottom portion 6f joined by these two slant portions 6g, 6g′.

A flat surface chamfer or a round surface fillet can be applied preferably on the corner edge 6e of the pressure contact blade receiving groove 6b. A pair of the pressure contact blade receiving grooves 6b are provided with a pair of a wire fixing portion 6h to fix the cables 4a, 4a′, as shown in FIGS. 3 and 6. The wire fixing portions 6h, as shown in FIG. 3, are located in a stagger for adjacent cables 4a, 4a′ of each other.

When connecting the pressure contact type terminal 5e with the cable 4a, 4a′, a pair of the slant portions 5g′ abut on the corner edges 6e of a pair of the pressure contact blade receiving grooves 6b and push inwardly a pair of the pressure contact blades 5f of the pressure contact type terminal 5e, as shown in FIGS. 6-8. Thereby, pressure contact connection of the pressure contact type terminal 5e and the cables 4a, 4a′ can be done securely.

FIG. 9 is an expanded perspective view of other embodiment of a pressure contact connector 5a mounted on the base board 2 provided with the camera 1 i.e. the camera module Y shown in FIG. 1. The shape of the pressure contact connector 5a is the same as mentioned above in FIG. 15 and then detailed description is omitted here.

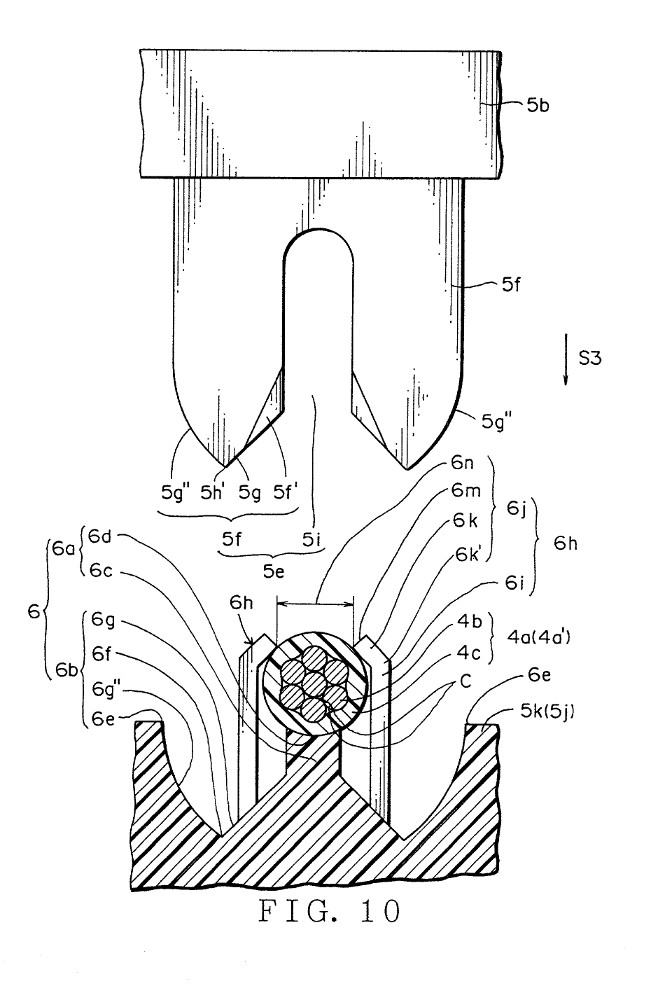

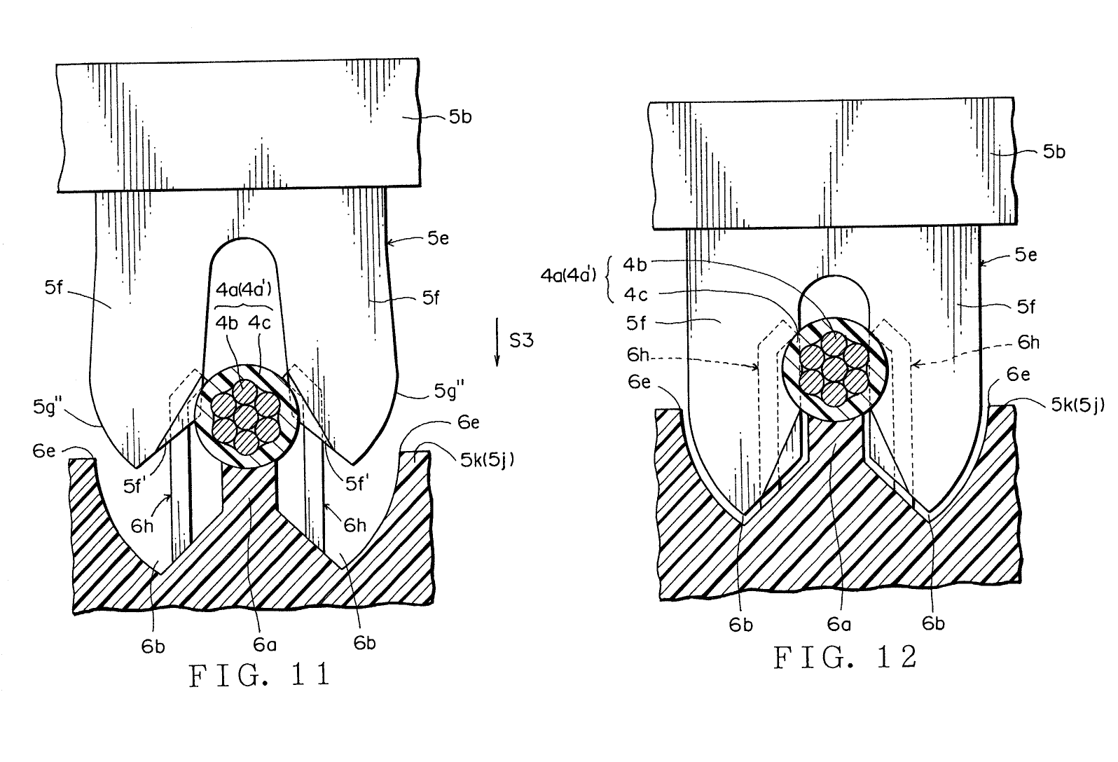

FIG. 10 is an expanded view, showing starting process for connecting the pressure contact type terminal 5e with the cable 4a, shown in FIGS. 1, 2, 3, 9. FIG. 11 is an expanded view, showing process after starting for connecting the pressure contact type terminal 5e with the cable 4a, shown in FIG. 10,along a mounting direction S3. FIG. 12 is an expanded view, showing finished condition for connecting the pressure contact type terminal 5e with the cable 4a, shown in FIG. 11.

Description on a shape of the pressure contact type terminal 5e shown in FIGS. 9-12 and an action of connecting the pressure contact type terminal 5e and the cables 4a, 4a′ is almost same as mentioned above in FIGS. 5-8, 15-18, and description on common matters is omitted herein. A point of difference between the pressure contact type terminal 5e shown in FIGS. 1, 6, 15, 16 and the pressure contact type terminal 5e shown in FIGS. 9, 10 will be described.

The pressure contact type terminal 5e, as shown in FIGS. 9, 10, is formed with a pair of the pressure contact blades 5f and the pressure contact slit 5i located between a pair of the pressure contact blades 5f. The pressure contact blades 5f are formed with a pair of the slant portions 5g for leading the cables 4a, 4a′ into the pressure contact slit 5i, arc portions 5g″ formed by continuous curve to be narrowed inwardly from outside edges of the pressure contact type terminal 5e, top portions 5h′ joined by the slant portions 5g and the arc portions 5g″ and blade portions 5f′ formed on the slant portions 5g.

The slant portions 5g are formed in a direction for leading easily the cables 4a, 4a′ into the pressure contact slit 5i of the pressure contact type terminal 5e. On the other hand, the arc portions 5g″ are formed into arc shape in an opposite direction against the slant portions 5g. Thus, top edges of the top portions 5h′ of the pressure contact type terminal 5e are formed into V-shape. Forming a pair of the arc portions 5g″ on the outside of the pressure contact type terminal 5e, a pair of the pressure contact blades 5f of the pressure contact type terminal 5e can be received satisfactorily into the pressure contact blade receiving grooves 6b through corner edges 6e of a pair of the pressure contact blade receiving grooves 6b, on connecting.

The positioning portion 6 is formed with the electric wire setting portion 6a, as shown in FIG. 10, provided on the bottom wall 5k of the connector housing and a pair of the pressure contact blade receiving grooves 6b provided at divided positions on the center of the electric wire setting portion 6a. The pressure contact blade receiving groove 6b is formed into similar shape to the outline shape of the top portion 5h′ of corresponding pressure contact type terminal 5e. Forming the pressure contact blade receiving groove 6b into a similar shape to the outline of the top portions 5h′ of the pressure contact type terminal 5e, the pressure contact type terminal 5e is received satisfactory into the pressure contact blade receiving groove 6b with no positioning error when connecting.

The shape of the electric wire setting portion 6a is the same as mentioned above in FIG. 6 and detailed description will be omitted here. The shape of the cables 4a, 4a′ mounted on the electric wire setting portion 6a is also the same as mentioned above in FIGS. 6, 16-18 and detailed description will be omitted here.

The pressure contact blade receiving groove 6b, as shown in FIG. 10, is formed with corner edges 6e, a groove bottom portion 6f, a slant portion 6g and a arc portion 6g″. Describing the pressure contact blade grooves 6b minutely, a pair of the pressure contact blade receiving grooves 6b are provided with a pair of arc portions 6g″ formed narrowing downwardly through the corner edge 6e from the surface of the bottom wall 5k of the connector housing, side walls of the pillar portion 6c, perpendicular to the surface of the bottom wall 5k of the connector housing, of the electric wire setting portion 6a, a pair of slant portions 6g formed spreading downwardly from the bottom edge of the side surface of the pillar portion 6c and the groove bottom portions 6f joined by arc portions 6g″ and slant portions 6g.

A flat surface chamfer or a round surface fillet can be applied preferably on the corner edge 6e of the pressure contact blade receiving groove 6b. A pair of the pressure contact blade receiving grooves 6b are provided with a pair of a wire fixing portion 6h to fix the cables 4a, 4a′.

When connecting the pressure contact type terminal 5e with the cable 4a, 4a′, a pair of the arc portions 5g″ formed on the pressure contact type terminal 5e abut on the corner edges 6e of a pair of the pressure contact blade receiving grooves 6b and push inwardly a pair of the pressure contact blades 5f of the pressure contact type terminal 5e, as shown in FIGS. 10-12. Thereby, pressure contact connection of the pressure contact type terminal 5e and the cables 4a, 4a′ can be done securely.

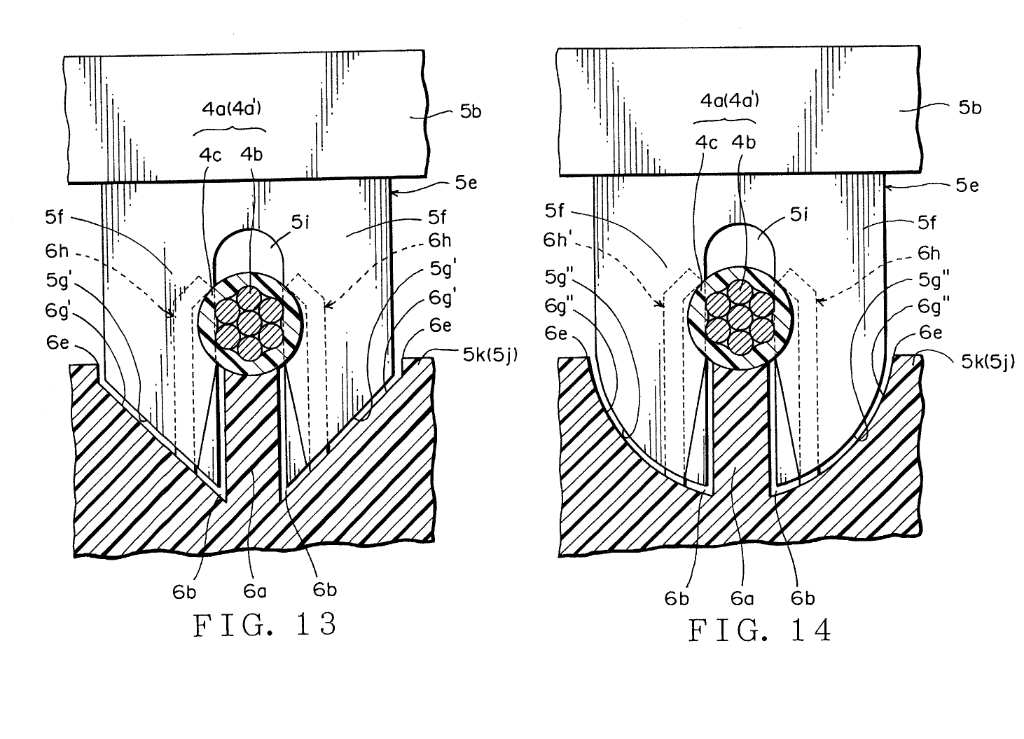

Not only the shape of the pressure contact type terminal 5e and the shape of the positioning portions provided with the electric wire setting portion 6a and the pressure contact blade receiving grooves 6b for positioning the cables 4a, 4a′, as mentioned above, but also shapes shown in FIG. 13, 14 can be used in this invention. FIG. 13 is a conceptual drawing, showing other embodiment of the pressure contact type terminal 5e and the positioning portion 6 shown in FIG. 6. FIG. 14 is a conceptual drawing, showing other embodiment of the pressure contact type terminal 5e and the positioning portion 6 shown in FIG. 10.

The pressure contact type terminal 5e and the positioning portion 6 shown in FIG. 6 and the terminal and the portion shown in FIG. 13 are almost same and differences between the pressure contact type terminals 5e and the positioning portion 6 shown in FIGS. 6 and 13 will be described mainly here. The pressure contact type terminal 5e shown in FIG. 13 is provided with a pair of the pressure contact blades 5f and the pressure contact slit 5i located between a pair of the pressure contact blades 5f. The pressure contact blades 5f includes a pair of the slant portions 5g′ formed narrowing from an outside edge of the pressure contact type terminals 5e and blade portions formed at top edge area by the pressure contact slit 5i and the slant portions 5g′. The blade portion is formed into sharp edge shape on a bottom half area of the pressure contact slit 5i to decrease gradually its thickness of the pressure contact type terminal 5e.

The pressure contact blade receiving groove 6b is formed into a similar shape to the outline of the top portion of the corresponding pressure contact type terminal 5e. The pressure contact blade receiving groove 6b is formed with a corner edge 6e, a groove bottom portion, a slant portion 6g′ and a side wall of the electric wire setting portion 6a. Describing the pressure contact blade groove 6b minutely, a pair of the pressure contact blade receiving grooves 6b are provided with vertical surfaces going down through the corner edges 6e from the surface of the bottom wall 5k of the connector housing, side walls of a pillar portion of the electric wire setting portion 6a parallel to the vertical surface, a pair of slant portions 6g′ formed narrowing downwardly along a line from a bottom edge of the vertical surface to a bottom edge of the side wall of the electric wire setting portion 6a and the groove bottom portions joined by the slant portions 6g′ and the bottom edges of the side surfaces of the pillar portion.

The pressure contact type terminal 5e and the positioning portion 6 shown in FIG. 10 and the terminal and the portion shown in FIG. 14 are almost same and differences between the pressure contact type terminals 5e and the positioning portion 6 shown in FIGS. 10 and 14 will be described mainly here. The pressure contact type terminal 5e shown in FIG. 14 is provided with a pair of the pressure contact blades 5f and the pressure contact slit 5i located between a pair of the pressure contact blades 5f. The pressure contact blades 5f includes a pair of the arc portions 5g″ formed narrowing from an outside edge of the pressure contact type terminals 5e and blade portions formed at top edge area by the pressure contact slit 5i and the arc portions 5g″. The blade portion is formed into sharp edge shape on a bottom half area of the pressure contact slit 5i to decrease gradually its thickness of the pressure contact type terminal 5e.

The pressure contact blade receiving groove 6b is formed into a similar shape to the outline of the top portion of the corresponding pressure contact type terminal 5e. The pressure contact blade receiving groove 6b is formed with a corner edge 6e, a groove bottom portion, an arc portion 6g″ and a side wall of the electric wire setting portion 6a. Describing the pressure contact blade groove 6b minutely, a pair of the pressure contact blade receiving grooves 6b are provided with vertical surfaces going down through the corner edges 6e from the surface of the bottom wall 5k of the connector housing, side walls of a pillar portion of the electric wire setting portion 6a parallel to the vertical surfaces, a pair of arc portions 6g″ formed narrowing downwardly from a bottom edge of the vertical surface to a bottom edge of the side wall of the electric wire setting portion 6a and the groove bottom portions joined by the arc portions 6g″ and the bottom edges of the side surfaces of the pillar portion.

A pair of the pressure contact blade receiving grooves 6b are provided with a pair of a wire fixing portion 6h to fix the cables 4a, 4a′ in FIGS. 13 and 14. A flat surface chamfer or a round surface fillet can be applied preferably on the corner edge 6e of the pressure contact blade receiving groove 6b.

The camera module Z shown in FIGS. 1 and 2 according to this invention will be described minutely with reference to FIGS. 5-14. The terminal 5e means the pressure contact type terminal 5e and the connecting portion 5e′ is provided with the cable 4a and the drain wire 4a′ and the base board 2 is provided with the pressure contact type connector 5a including the pressure contact type terminals 5e. The camera case 3 is provided, in a receiving section 5m, with the connector housing 5j including the cable 4a and the drain wire 4a′ inside.

Fitting the base board 2 provided with the camera 1 and the pressure contact type connector 5a into the camera case 3, the cables 4a and the drain wire 4a′ are connected by pressure contacting to form into the connector 5. The positioning portion 6, as shown in FIGS. 6 and 10, is provided with the electric wire setting portions 6a and the pressure contact blade receiving grooves 6b. Pressure contact connecting is done by guiding the pressure contact blades 5f of the pressure contact type terminal 5e into the pressure contact blade receiving grooves 6b. Thus, electrical connection can be done easily during assembling operation by pressure-contact connecting specifically with the pressure contact type terminals 5e.

Regarding an auxiliary device module by prior art, operation of connecting securely pressure contact type terminals 5e with electric wires 4a, 4a′ requires to pay much attention. An auxiliary device module Z failed in continuity test after operating pressure contact connection must be treated as a defective product.

If pressure contact connection are applied again on the same position of electric wires 4a, 4a′ which had be sheared once by pressure contact type terminals 5e, the second electrical disconnection on the positions is concerned. Therefore, electric wires 4a, 4a′ applied pressure contact connection must be replaced or the other positions of the electric wires instead of the positions applied pressure contact connection previously must be connected with pressure contact type terminals.

However, in a module according to this invention, an auxiliary device module Z is provided in the positioning portion 6 with pressure contact blade receiving grooves 6b for guiding pressure contact type terminals 5e into the connector and then, when mounting a base board 2 mounted with the pressure contact type terminals 5e on a camera case 3, electrical connection can be done by guiding securely the pressure contact type terminals 5e on the electric wires 4a, 4a′ in a connector housing 5j. Therefore, failed products mentioned above can be reduced and product yield can be improved.

Describing in detail, a connector housing 5j is provided in positioning portions 6 with pressure contact blade receiving grooves 6b for leading pressure contact type terminals 5e and pressure contact connection is done by leading a pair of the pressure contact blades 5f of the pressure contact type terminals 5e into pressure contact blade receiving grooves 6b. Thereby, the slits 5i of the pressure contact type terminals 5e are successfully led to contact with electric wires 4a, 4a′, 4b such as cables 4a, 4a′ provided in the receiving section 5m of the connector housing 5j when fitting the base board 2 provided with the pressure contact type terminals 5e i.e. the camera module Y into the camera case 3.

A pair of the pressure contact blades 5f of the pressure contact type terminals 5e dig into electric wires such as cables during the pressure contact type terminals 5e is guided by the pressure contact blade receiving grooves 6b. Therefore, a pair of the pressure contact blades 5f may not be expanded easily. Fitting the camera module Y including the base board 2 into the camera case 3 and electrically connecting can be simultaneously done easily and securely.

Action of a pair of the pressure contact blades 5f formed in the pressure contact type terminal 5e when connecting the pressure contact type terminals 5e with electric wires 4a, 4a′ will be described with reference to FIGS. 6-8, 10-12. A pair of the pressure contact blades 5f formed in the pressure contact type terminal 5e are guided inwardly by the corner edges 6e of the pressure contact blade receiving grooves 6b.

Thereby, since a pair of the pressure contact blades 5f formed in the pressure contact type terminal 5e are guided by corner edges 6e of the pressure contact blade receiving grooves 6b, the pressure contact type terminal 5e abuts on the corner edges 6e of the pressure contact blade receiving grooves 6b and a pair of the pressure contact blades 5f of the pressure contact type terminal 5e are guided inwardly, when the pressure contact type terminals 5e are connected with electric wires 4a, 4a′ and a pair of the pressure contact blades 5f of the pressure contact type terminal 5e may be expanded outwardly.

If a pair of the pressure contact blades 5f of the pressure contact type terminal 5e may be expanded markedly when pressure contact connecting the pressure contact type terminals 5e with electric wires 4a, 4a′, deformation of the pressure contact blades 5f of pressure contact type terminals 5e is concerned. When the pressure contact blades 5f of pressure contact type terminals 5e are deformed, the pressure contact type terminals 5e and electric wires 4a, 4a′ may not be connected securely. However, according to this invention, a pair of the pressure contact blades 5f of the pressure contact type terminal 5e are guided inwardly by the corner edges 6e of the pressure contact blade receiving grooves 6b and then above failure can be prevented.

Describing simply a terminal, terminals are classified into a pressure contact type terminal and a crimp contact type terminal. Regarding the pressure contact type terminal 5e, as mentioned above with reference to FIGS. 5-18, pressure contacting the blade portion 5f′, formed on the pressure contact blade 5f of the pressure contact type terminal 5e, with the electric wire 4 such as the cables 4a, 4a′ formed with the conductive wires 4b, protected by the insulation cover 4c, shearing the insulation cover 4c and connecting with the conductive wires 4b can be done simultaneously. A terminal provided with U-shape contact with the pressure contact slit 5i is a typical example. The pressure contact slit 5i can be called simply a slit.

On the other hand, a crimp contact type terminal is provided with a barrel portion, plastic deformed by a crimping tool to connect an electric wire mechanically and electrically. Generally, the barrel portion includes a wire barrel, for crimp contacting with a conductive wire at insulation cover removed area, and an insulation barrel for crimp contacting an insulation cover area of an electric wire. The wire barrel is classified into a closed barrel and an open barrel.

Preferably, in this invention, the pressure contact type connector 5a mounted on the base board 2 as shown in FIG. 1 may be replaced by a male type or female type connector with crimp contact type terminals and a portion including cables 4a, 4a′ in the connector housing 5j may be replaced by a female type or male type connector which can be connected correspondingly with the above connector and inserting correspondingly connecting terminals to the above terminals into this connector is effective.

Furthermore, portions of the cables 4a, 4a′ mounted in the connector housing 5j may be replaced by bus bars and ends of the bus bars may be formed into required terminal shape to connect with connector elements on the base board. Assuming to meet the objects of this invention, any type terminals and connectors can be used.

Various kind of electric circuit elements, such as bus bars, terminals and electric wires for connecting with electric wiring are provided and retained on the base board body 2'shown in FIG. 1. The base board 2 is an insulating plate to retain such electric circuits and to prevent electrical contacting between each electric circuits and can be called “insulated board”.

Describing a material to form the base board 2, synthetic resin such as thermosetting resin or thermoplastic resin is preferable for good formability and good performance to insulate various electric elements such as bus bars or terminals. Any above synthetic resin with low water absorbing property is preferable on dimensional stability, volume productivity and stable electric performance.

The bus bar is made of conductive sheet metal to branch plural electric circuits and electrical circuit network with many electric contact pieces. Provided bus bars are a bus bar body, a bus bar for connectors, a bus bar for relay, a bus bar for fuse, a bus bar for power supply or the like. The bus bar for fuse is called a clamp hold type terminal or a tuning fork shape terminal by the formed shape. The bus bars may be provided with junction terminals if required.

Copper-base metal such as bronze or copper alloy and aluminum alloy may be listed as materials for the pressure contact terminal 5e or bus bars used in this invention. Electrical conductive metal or any kind of materials having good electrical conductivity may be used for the pressure contact terminal 5e or bus bars used in this invention.

Applying surface protecting process such as metal plating on above material for enhancement of corrosion resistance is preferable. If the performance can be kept enough under normal working condition without surface treatment, such surface protecting process may not be applied preferably in a viewpoint of cost.

The camera case 3, shown in FIGS. 1 and 2, is formed with a bottom wall 3c and side walls 3d, 3d′ standing around the bottom wall to provide a receiving section 3e. The camera case 3, as shown in FIGS. 1, 2 and 4, is provided with a mat seal 9 integrally molded in the side wall 3d′ to enhance sealing performance. The mat seal 9 is provided with through holes 9a for inserting cables 4a and a drain wire 4a′. The cables 4a, 4a′ are led from outside into an inside of the camera case 3 through the mat seal 9.

The form of the mat seal 9 will be described in detail with reference to FIG. 2. The mat seal 9 is integrally molded from a round portion of a through hole 3f formed in the side wall 3d′ of the camera case 3 to a side wall 5k″ forming an end portion of the connector housing 5j. The mat seal 9 is provided on a side of receiving section 3e of the camera case 3 with a locking portion 9b to prevent dropping through from the through hole 3f of the camera case 3. The locking portion 9b formed on the mat seal 9 is fixed in the camera case 3 to be integrally molded and sandwiched between an inner surface of the side wall 3d′ of the camera case 3 and an outer surface of the side wall 5k″ of the connector housing 5j.

Describing manufacturing method of the mat seal 9, firstly the camera case 3 is manufactured by aluminum casting mold method. Or, the camera case 3 is formed with synthetic resin which can be injection molded and has thermoplastic property. After pouring synthetic polymer, such as granular silicon, into the through hole 3f and surrounding area of the camera case 3, the mat seal 9 is formed into a required shape to solidify the polymer.

In the process, after fixing the cables 4a, 4a′ in a through hole 5m′ of the connector housing 5j formed in the receiving section 3e of the camera case 3, the cables 4a, 4a′ and the mat seal 9 may be integrally molded. On the other way, molding the mat seal 9 to form the through holes 9a in preprocess, the cables 4a, 4a′ may be inserted into the through holes 9a formed in the mat seal 9.

Thus, the mat seal 9 is formed integrally between the side wall 3d′ of the camera case 3 and a side wall 5k″ forming an end portion of the connector housing 5j. And the cables 4a, 4a′ sealed by the mat seal 9 are inserted from a connecting case 7 toward the receiving section 5m of the connector housing 5j. The through hole 3f formed in the side wall 3d′ of the camera case 3 is sealed by the mat seal 9.

Providing the mat seal 9 as mentioned above, electric wires such as the cables 4a and the drain wire 4a′ can be inserted from the outside into the inside of the camera case 3 and penetration of contaminants such as water or dust into the inside of the camera case 3 can be protected.

The camera case 3 is provided on the inner four corners with screw fixing bodies 3a, 3a′ to fix the camera module Y including the camera 1 and the base board 2, as shown in FIGS. 1, 2. Each screw fixing body 3a, 3a′ is provided with a female tapped hole 3b. One female tapped hole 3b is formed in each screw fixing body 3a, 3a′ provided on the camera case 3 and total 4 tapped holes are provided on the camera case.

Location of the four female tapped holes 3b will be described with reference to FIG. 1. Two screw fixing bodies 3a on a front side are placed higher than positions of two fixing bodies 3a′ on a rear side. Therefore, Positions of the female tapped holes 3b of two screw fixing bodies 3a provided on the front side are placed higher than positions of the female tapped holes 3b of two screw fixing bodies 3a′ provided on the rear side.

The height position difference of the screw holes, as showing the camera module Y mounted with the camera 1 and the base board 2 in FIG. 1, is for shifted height position of screw fixing bodies 1a on the camera 1 against height position of screw bodies 2a on the base board 2 to assemble combination of the camera 1 and the base board 2 into the camera case.

The camera body 1′ is provided with two screw fixing bodies 1a and the base board body 2′ is provided with two screw fixing bodies 2a and then combining the camera 1 and the base board 2 gives total four screw fixing bodies 1a, 2a provided on the camera module Y. When combining the camera and the base board, respective screw fixing bodies 1a, 2a will not have the same height. Therefore, as shown in FIG. 1, height difference between the screw fixing bodies 3a, 3a′ of the camera case 3 is given to adjust the height position of the screw fixing bodies 1a, 2a of the camera module Y.

Preferably, the camera case 3, as showing one embodiment of the invention, may be formed with aluminum alloy by aluminum die cast to be lightweight and have many advantages on mechanical strength, anti-corrosion, manufacturability and productivity. Since CCD camera mounted on the outside of a car is exposed to the weather, anti-corrosion material is very important. Small specific gravity material is preferable to save weight in a car. For a material of the camera case 3 used for above application, aluminum alloy or synthetic resin which can be injection molded and has thermoplastic property may be preferable to be good for mass production.

The connector housing 5j, as shown in FIGS. 1 and 2, is formed integrally with the camera case 3 in the receiving section 3e of the camera case 3. The connector housing 5j can be provided as a separated element for the camera case 3. Preferably, the connector housing 5j may be formed integrally with the camera case 3 to reduce number of elements and cost. The connector housing 5j may be formed into a size corresponding to a shape of the pressure contact type connector 5a, shown in FIGS. 1, 5, 9 and 15.

The connector housing 5j, as shown in FIGS. 1 and 2, is provided with a receiving section 5m formed with a bottom wall 5k and side walls 5k′, 5k″ on all sides. The cables 4a and the drain wire 4a′, as shown in FIGS. 1 and 2, are installed in the receiving section 5m of the connector housing 5j. Respective cables 4a, 4a′ including the drain wire 4a′ is held by a wire fixing portion 6h provided on the bottom wall 5k of the connector housing 5j.

The cables 4a, 4a′, as shown in FIG. 2, are arranged at even intervals in a row in the receiving section 5m of the connector housing 5j. An opening portion 5n is provided on a top side of the receiving section 5m of the connector housing 5j to connect the pressure contact type terminals 5e, mounted in the pressure contact type connector 5a, with each cable 4a, 4a′ installed in the receiving section 5m of the connector housing 5j.

The wire fixing portions 6h are provided in stagger on the front-and-rear and right-and-left side of each cable 4a, 4a′, as shown in FIGS. 1-3. Providing adjacent wire fixing portions 6h of each other in stagger in the receiving section 5m of the connector housing 5j , the receiving section 5m of the connector housing 5j can be sized smaller. Therefore, miniaturized and weight saved auxiliary device module Z, such as a camera module Z, can be provided by miniaturizing the camera case 3.

At least two wire fixing portions 6h for fixing the cables 4a, 4a′ in the receiving section 5m of the connector housing 5j are provided for one cable 4a, 4a′, as shown in FIGS. 1 and 2. A pair of wire fixing portions 6h, as shown in FIG. 2, are provided on the cable 4a, 4a′. Two wire fixing portions 6h are provide along the length of the cable 4a, 4a′ and total twelve wire fixing portions are provided in the receiving section 5m of the connector housing 5j.

Therefore, the cables 4a, 4a′ are fixed in required position during operation of pressure contact connecting and when the pressure contact blades 5f of the pressure contact type terminal 5e, shown in FIGS. 7 and 11, are starting to shear the cables 4a, 4a′, the cables 4a, 4a′ can not flee from pressing force by the pressure contact blades 5f (pressure contact force) and can catch the pressure contact force securely. Thus, pressure contact connection can be done satisfactorily.

Preferably, a through hole 5m, formed in the side wall 5k″ of the connector housing 5j shown in FIG. 2, may perform to fix the cables 4a, 4a′ more securely, adding to fixed position by above wire fixing portions 6h.

A shape of the wire fixing portion 6h, shown in FIGS. 1-3, will be described in detail with reference to FIGS. 6 and 10. The wire fixing portion 6h is formed into gate shape with a pair of inverted L-shape portions, as shown in FIGS. 6 and 10, to hug the cables 4a, 4a′.

The wire fixing portion 6h is provide mainly with a pillar portion 6i and locking portion 6j. The pillar portion 6i of the wire fixing portions 6h extend upwardly from the pressure contact blade receiving grooves 6b formed on the bottom wall 5k of the connector housing and the locking portions 6j for preventing the cables 4a, 4a′ coming out are formed on a top of the wire fixing portion 6h. The locking portion 6j is formed with a slant portion 6k, a bend portion 6k′ and an edge portion 6m.

A pair of the wire fixing portions 6h are formed with the slant portions 6k to be bent at the bend portions 6k′ as closing the edge portions 6m of the wire fixing portions 6h to each other. The bend portion 6k′ may be curved shape or curved from the pillar portion 6i to the slant portion 6k of the wire fixing portion 6h.

The edge portions 6m and side edges of a pair of the electric wire fixing portions 6h hug the cables 4a, 4a′ and touch surfaces of the cables 4a, 4a′ to hold the cables. Thus, a pair of the electric wire fixing portions 6h fix the cables 4a, 4a′.

The edge portion 6m is formed into a slant surface going down toward the electric wire setting portion 6a to fit the cables 4a, 4a′ easily on the electric wire fixing portion 6h when fixing the cables 4a, 4a′ on the electric wire fixing portion 6h.

The minimum gap distance 6n between one edge portion 6m and the other edge portion 6m of the electric wire fixing portions 6h is dimensioned to be smaller than a diameter of the cable 4a, 4a′ for preventing the cables 4a, 4a′ coming out from the wire fixing portions 6h and also to fit the cable 4a, 4a′ easily into the wire fixing portions 6h.

The electric wires 4a, 4a′ such as cables 4a, 4a′ are fixed actually by three points of two side edges of the edge portions 6m of a pair of the electric wire fixing portions 6h and one supporting portion 6d formed on the top of the pillar portion 6c of the electric wire setting portion 6a. Thus, fixing the cables 4a, 4a′ by the three points of a pair of the electric wire fixing portions 6h and the supporting portion 6d of the electric wire setting portion 6a, the cables 4a, 4a′ are held stably in the connector housing.

The shape of the supporting portion 6d formed on the top of the pillar portion 6c of the electric wire setting portion 6a is formed into in-curved shape correspondingly to an outline surface of the electric wires 4a, 4a′ such as the cables 4a, 4a′ and then it is easy to set the cables 4a, 4a′ stably on the supporting portion 6d of the electric wire setting portion 6a.

Since the width of the pillar portion 6c of the electric wire setting portion 6a is dimensioned to be narrower than the width of the pressure contact slit 5i of the corresponding pressure contact type terminal 5e, the top edge portion of the pressure contact type terminal 5e can be received satisfactorily into the pressure contact blade receiving grooves 6b, as shown in FIGS. 8, 12-14.

Dimensioning the width of the pillar portion 6c of the electric wire setting portion 6a narrower than the width of the pressure contact slit 5i of the corresponding pressure contact type terminal 5e, pressure contact connecting may be done expectably by the pillar portion 6c of the electric wire setting portion 6a guiding the pressure contact slit 5i of the corresponding pressure contact type terminal 5e. Thereby, pressure contact connecting may be done more stably and more securely.

Some clearance between the cables 4a, 4a′ and the pressure contact blade 5f is required to accept error of positioning each elements or position moving during pressure contact connection. Therefore, the length between one inner surface and the other inner surface of the pillar portion 6i, provided in the wire fixing portion 6h is dimensioned to be longer than a diameter of the cable 4a, 4a′ as allowance for positioning error during pressure contact connection.

If the cables 4a, 4a′ are fixed during operation of pressure contact connecting, as mentioned above, when the pressure contact blade 5f of the pressure contact type terminal 5e is starting to shear the cables 4a, 4a′, the cables 4a, 4a′ can accept the pressure contact force on the pressure contact blade 5f. Then, pressure contact connection can be done satisfactorily without the cables 4a, 4a′ shifting.

The wire fixing portion 6h may be formed with synthetic resin which can be injection molded and has thermoplastic property. The wire fixing portion 6h can be integrally molded with the connector housing 5j by the same material or may be molded as a separated element by each different material and be mounted in the receiving section 5m of the connector housing 5j.

The cables 4a, 4a′, connected by pressure contact, are bundled by the tube 4d, as shown in FIG. 2, to form into the wire harness 4 which is connected with specific portions in a car. The wire harness may be formed with a dummy wire added on the cables 4a, 4a′ to be connected with other electric circuits if required.

The wire harness 4 connects the camera case 3 and the non-waterproof connector 5r installed in the inside-of-car V. The drain wire 4a′, branched from a middle point of the wire harness 4, is provided at one end with a terminal 5s and the terminal 5s is fixed on a frame of a car body B with a screw 13c. The drain wire 4a′ performs earth ground. Thus, the base board 2 including the camera 1, the wire harness 4, the non-waterproof connector 5r installed in the inside-of-car V and the drain wire 4a′ are connected electrically to each other.

The connecting case 7, as shown in FIGS. 1, 2 and 4, is provided on the side wall 3d′ of the camera case 3. A connecting case cover 8 is provide to be mounted correspondingly on the connecting case 7. The connecting case 7 and the connecting case cover 8 are provided to prevent over loading of bending force on the wire harness 4 and protect the cables 4a, 4a′ coming out from the tube 4d of the wire harness 4 and the mat seal 9 for inserting the cables and place the cables 4a, 4a′ coming out from the tube 4d of the wire harness 4 in a row.

The connecting case 7 may be formed integrally with the camera case 3 or may be mounted on the camera case 3 as a separated element from the camera case 3. Preferably, the connecting case 7 may be formed integrally with the camera case 3 to reduce number of elements.

The connecting case 7 is provided with a receiving section 7c formed with a bottom wall 7a and side walls 7b, 7b′ around the bottom wall 7a. The connecting case 7 is provided in the receiving section 7c with a guide plate 7d to arrange the cables 4a, 4a′ in parallel and in a row. The number of guide grooves 7e as the same number, for example 6, of the cables 4a, 4a′, as shown in FIG. 4, is provided at even intervals on a top side of the guide plate 7d to fix the cables 4a, 4a′ in a row. A wire guide portion 7f for guiding the wire harness 4 is formed along a fitting direction to the wire harness 4 and extending from the side wall 7b′, as shown in FIGS. 1 and 2, to prevent over loading of bending force on the wire harness 4.

A connecting case cover 8 is provide to be mounted correspondingly on the connecting case 7, as shown in FIGS. 1 and 4. FIG. 4 is a sectional view taken along the line P-P of FIG. 1 showing the connecting case 7 and the connecting case cover 8. The connecting case cover 8 is provided with a receiving section 8c formed with a top wall 8a and side walls 8b, 8b′ around the top wall 8a.

A guide plate 8d, having guide grooves 8e corresponding to the guide grooves 7e formed in the guide plate 7d of the connecting case 7, is provided in the connecting case cover 8. Describing in detail, the guide plate 8d for placing the cables 4a, 4a′ in parallel and in a row is provided in the receiving section 8c of the connecting case cover 8.

The number of guide grooves 8e as the same number, for example 6, of the cables 4a, 4a′ are provided at even intervals on a bottom side of the guide plate 8d to fix the cables 4a, 4a′ in a row. A wire guide portion 8f for guiding the wire harness 4 is formed along a fitting direction to the wire harness 4 and extending from the side wall 8b′, as shown in FIG. 1, to prevent over loading of bending force on the wire harness 4.

The guide grooves 7e, Be for fixing the cables 4a, 4a′ separated from the wire harness 4 are provided at even intervals on the connecting case 7 and corresponded connecting case cover 8. Fixing the connecting case cover 8 on the connecting case 7 from mount direction S2 shown in FIG. 4, each cable 4a, 4a′ is clamped and fixed by the guide grooves 7e of the connecting case 7 and the guide grooves 5e of the connecting case cover 8. The guide plate 7d, 8d having guide grooves 7e, Be may be called a rib.

Fixing the connecting case cover 8 on the connecting case 7, the wire guide portion 7f formed on the connecting case 7 and the wire guide portion 5f formed on the connecting case cover 8 are combined to prevent over loading of bending force on the wire harness 4.

Since the wire guide portions 7f, 8f for the electric wire 4 such as the wire harness 4, are provided on the connecting case 7 and the corresponded connecting case cover 8 as shown in FIGS. 1 and 2, the cables 4a, 4a′ can not be bent with a sharp corner on a mounting area of camera case 3 and prevented over loading of bending force on them, during arranging the wire harness 4 or handling the assembled camera module Z.

The connecting case 7 and the connecting case cover 8, as shown in FIGS. 1 and 4, are fixed securely by a pair of locking portions 7g provided outside of the side walls 7b of the connecting case 7 and a pair of engaging portions 8g provided outside of the side walls 8b of the connecting case cover corresponding to the locking portions 7g. Fitting the convex shape locking portion 7g into the engaging portions 8g provided with engaging openings corresponding to the locking portions, the connecting case 7 and the connecting case cover 8 are fixed.

The connecting case cover 8 is made of synthetic resin by injection molding. As shown in this embodiment, forming with synthetic resin which can be injection molded and has thermoplastic property is preferable for mass production. Not only injection molding but also the other manufacturing method can be used. Forming not only the connecting case cover 8 but also the camera case 3 integrally with the connecting case 7 by injection molding with synthetic resin which can be injection molded and has thermoplastic property is good mass productivity for any complicated shape, in this invention.

A molded body with synthetic resin may have good spring back force potentially inside. If the connecting case cover 8 is formed by synthetic resin molding, during fitting the engaging portions 8g of the connecting case cover 8 into the locking portion 7g of the connecting case 7 shown in FIGS. 1 and 4, the engaging portion 8g is elastically deformed temperately and the locking portion 7g goes easily into the engaging opening of the engaging portion 8g and then the connecting case 7 and the connecting case cover 8 are fixed rapidly and easily.

As synthetic resin which can be injection molded and has thermoplastic property, polybutylene terephthalate (PBT for short), acrylonitrile butadiene styrene (ABS for short) and polypropylene (PP for short) are given examples. The connecting case cover 8 used in this invention is made of polybutylene terephthalate (PBT) as an example which has good stability on dimension and strength and good electrical characteristics. PBT-HOl is given an example as PBT materials.

Regarding manufacturing method of the auxiliary device module Z such as the camera module Z, an example for assembling process and method of the camera module Z will be described with reference to FIGS. 1-18.

Terminals such as various pressure contact type terminals 5e and various bus bars are manufactured to be respective required shapes by punching and bending process with metals for terminals. In other process, the base board 2 is formed with thermosetting resin or the like and the connector housing 5b is injection molded with thermoplastic resin. The various bus bar, the connector housing provided with the pressure contact type terminals 5e and other various electric elements are mounted on the base board 2.

The camera 1 provided with the lens 1c, the lens area portion 1d and camera body 1′ shown in FIG. 1 is prepared in preprocess. The camera module Y is prepared to mount the camera 1, the pressure contact type connector 5a provided with the pressure contact type terminals 5e and other various electric circuits on the base board 2 in preprocess, as shown in FIG. 1.

The camera case 3 formed integrally with the connector housing 5j and the connecting case 7 shown in FIGS. 1 and 2, the connecting case cover 8 shown in FIGS. 1 and 4, the wire fixing portion 6h shown in FIGS. 3, 6 and 10 are molded with synthetic resin which can be injection molded and has thermoplastic property in other process. The wire fixing portion 6h may be mounted on a required position in the connector housing 5j , as shown in FIGS. 1-3, 6 and 10, or may be formed integrally with the connector housing 5j by the same material.

Regarding the wire harness 4 shown in FIGS. 1 and 2, the cables 4a and the drain wire 4a′ are prepared to come out with required length from the tube 4d by shearing the tube 4d in preprocess.

The cables 4a, 4a′ are inserted through the through hole 5m′ formed in the side wall 5k″ of the connector housing 5j provided in the camera case 3 and set into the wire fixing portion 6h provided in the receiving section 5m of the connector housing 5j. Each of the cables 4a, 4a′ is fixed securely in two positions by the wire fixing portion 6h.

The cables 4a, 4a′ may be fixed on the side wall 5k″ with adhesive to fix the cables 4a, 4a′, inserted through the through hole 5m′ provided in the side wall 5k″ of the connector housing 5j, on the side wall 5k″ securely, if required.

The cables 4a, 4a′ are also set in a row into the guide grooves 7e formed on the guide plate 7d of the connecting case 7, as shown in FIGS. 1, 2 and 4. After pouring synthetic polymer, such as granular silicon, into the through hole 3f and surround area of the camera case 3, the mat seal 9 is formed into a required shape to solidify the polymer.

The base board 2 having the camera 1 and the pressure contact type connector 5a, i.e. the camera module Y, is fit into the camera case 3. During this assembling operation, the pressure contact blades 5f of the pressure contact type terminals 5e, mounted in the pressure contact type connector 5a, shears the insulation cover 4c of the cables 4a, 4a′ fixed on the connector housing 5j and contacts with the conductive wires 4d simultaneously and then internal connecting in the camera module z is done. In the process, the pressure contact type terminal 5e is led into the pressure contact blade grooves 6b formed on the bottom wall 5k of the connector housing 5j and then pressure contact connection can be done satisfactorily. Thus, the base board 2 and the camera case 3 are electrically connected by the connector 5.

Specifically, connecting by the pressure contact type terminal 5e, assembling and electrical connecting can be done effectively and simultaneously in the process. In this invention, other type of female-male connector may be used. Regarding connecting by the pressure contact type terminals 5e, shearing the insulation cover 4c and connecting with conductive wire 4b can be done simultaneously, as mentioned above, and then such connecting method is effective. After stripping insulation covers of cables to make inner conductive wires come out and connecting the conductive wires with crimp type terminals by prior art, each corresponded crimp type terminals are connected. Therefore, connection by pressure contact type terminals can save labor operation to connect each corresponded crimp type terminals.

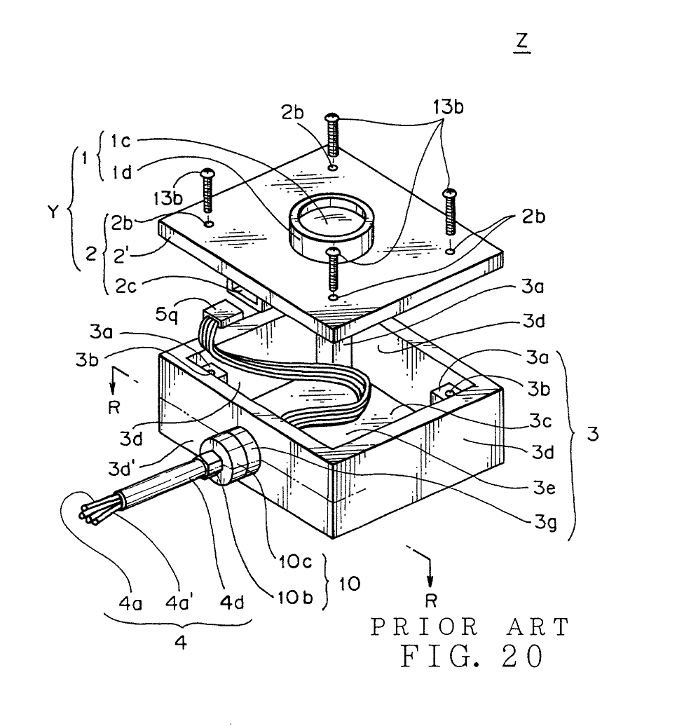

Assembling the camera module Z by such process, electrical connection can be done by fitting the base board 2 provided with the camera 1 into the camera case 3. As prior art shown in FIGS. 20-22, joining the connector housing 5q having terminals with the cables 4a, 4a′ and inserting the connector housing into the through hole 3f of the camera case 3 and connecting the connector housing with the connector housing 2c provided with terminals and mounted on the base board body 2′, the base board 2 and the wire harness 4 are electrically connected. The camera module Z can be assembled by pressure contact type terminals without such operation. Thus, assembling operation by this invention can be simplified more than that by prior art and then assembling operation can be simplified and more rapid and operating efficiency can be improved.

A trouble of the camera module Z by prior art during assembling can be solved. The trouble that the cables 4a, 4a′ are bitten by a gap between the base board 2 and camera case 3 during fitting the base board 2 having the camera 1 into the camera case 3 can be prevented. In this invention, the base board 2 provided with the camera 1 and the camera case 3 are connected by the pressure contact type connector 5a and then the trouble of biting cables 4a, 4a′ is not concerned.

Specifically, during mounting the camera module Y on the camera case 3 by prior art as shown in FIG. 21, extra length portions of the cables 4a, 4a′ come out from a gap between the camera module Y and the camera case 3 and the coming out portions of the extra length of the cables 4a, 4a′ are bitten. In this invention, such trouble is not occurred.

Therefore, an operator is not required to pay over attention to prevent biting the cables 4a, 4a′ between the base board 2 and the camera case 3 during assembling the base board 2 and the camera case 3. In automatic assembling machines, the automatic assembling machines are not stopped by biting the cables 4a, 4a′ and yield down of the camera module Z in process by damaged cables by biting is not concerned.

After putting the camera module Y, shown in FIG. 1, into the camera case 3 in mount direction S1, four screws 13a are inserted into the screw through hole 1b, 2b formed in each screw fixing portion 1a, 2a. Respective screw 13a is fastened by a screwdriver into each female tapped hole 3b of each screw fixing body 3a, 3a′ provided on the four corners of the camera case 3. During the operation, pressure contact connection may be going securely. A case cover for protecting an auxiliary device such as the camera 1 may be mounted on the case 3 simultaneously, if required.

In above operation, simultaneously mounting the connecting case cover 8 on the connecting case 7 as shown in FIG. 4, the cables 4a, 4a′ are fixed securely by the guide grooves 7e formed in the guide plate 7d of the connecting case 7 and the guide grooves 8e formed in the guide plate 8d of the connecting case cover 8. Thus, the camera module Z is assembled in above process.

Any kind of additional elements, such as a case cover, may be mounted on the auxiliary device module according to this invention, based on requirements as mentioned above. Some additional elements such as the case cover may be eliminated based on a used position of the auxiliary device or a mounting position of the auxiliary device. Thereby, number of elements can be reduced and then the auxiliary device module can be miniaturized and saved in weight and a lower cost auxiliary device module can be provided.

The auxiliary device module Z according to this invention can be applied not only for the camera module Z mentioned above but also auxiliary device modules Z used for an instrument panel of a car or other related area and can be applied for any other area for modularization.

The camera module Z provided with the camera 1 including CCD, as the auxiliary device 1, for a car is preferable in any auxiliary device modules. Applying the auxiliary device module Z according to the invention for camera module Z mounted in a car, number of elements related with the camera module Z can be reduced and then, the camera module Z mounted in a car can be miniaturized and the weight and the cost also can be reduced.

Assembling structure of the camera 1, the base board 2 and the camera case 3 for a car is simplified. Describing specifically, using pressure contact type terminals 5e as show in FIGS. 1, 5-18, the structure differs from a current camera module Z which has a wire harness 4 including a clamp 10 with O-ring 11 shown in FIG. 19 or a camera module Z by prior art, shown in FIG. 24, in which crimp contact type terminals 5p are joined with the cables 4a, 4a′ and the assembly is set into the connector housing 5q and the connector housing 5q is connected with the connector housing 2c for the base board 2 as shown in FIGS. 20, 21 and then electrical connection is done.

According to this invention, using pressure contact type terminals 5e provided in the pressure contact type connector 5a, shown in FIGS. 1, 5 and 9, to connect electrically from a camera 1 to a wire harness 4 by pressure contact connecting as shown in FIGS. 10-14, inspection, disassemble and repair can be done easily and also the camera module having good recyclability can be provided.

The camera module Z according to this invention is preferably used as an auxiliary member to ascertain safety of a dead angle to be installed in positions to look from a inside of a vehicle such as a dead angle area in front of a vehicle or rear area of a vehicle such as a normal size car or a large size car like a bus.

When a CCD camera installed on a outside of a car rear area strikes against others during moving back and checking or repairing of the CCD camera is required, a CCD camera according to this invention is easily disassembled and then the damaged CCD camera can be disassembled easily and repaired and reinstalled on the car. Therefore, a module according to this invention is used preferably as a CCD camera for ascertaining visually installed on a outside of a car rear area.

When a CCD camera or related elements installed on a car has a trouble such as a fault, removing , checking and repairing of them are required. A camera module Z according to this invention, which can be easily installed and removed, has good maintainability. Since the camera module Z is disassembled easily, the camera module Z is easily recycled in case of scrapping and then conform to a environmental issue by industrial waste.

What is claimed is:

1. An auxiliary device module comprising:
an auxiliary device;
a base board provided with said auxiliary device and terminals; and
a case in which said base board is mounted, wherein said terminals on the base board and a connecting portion in said case are electrically connected as a connector by mounting said base board on the case, wherein positioning portions for the terminals are provided in the connecting portion of said connector.

2. The auxiliary device module according to claim 1, wherein said terminals are pressure contact type terminals, wherein said connecting portion includes electric wires, wherein a pressure contact type connector provided with said pressure contact type terminals is mounted on said base board, wherein said case is provided with a connector housing having said electric wires therein, wherein said connector is formed by press-fitting said base board into said case to connect said pressure contact type terminals with said electric wires by pressure, wherein said positioning portions include electric wire setting portions and pressure contact blade receiving grooves, wherein pressure contact connecting of the terminal and the electric wires is done by leading pressure contact blades of said pressure contact type terminals into said pressure contact blade receiving grooves.

3. The auxiliary device module according to claim 2, wherein a pair of said pressure contact blades formed in said pressure contact type terminals are guided by corner edges of said pressure contact blade receiving grooves.

4. The auxiliary device module according to claim 1, wherein a camera module is built with a car-mount type camera as said auxiliary device.

5. The auxiliary device module according to claim 2, wherein a camera module is built with a car-mount type camera as said auxiliary device.

6. The auxiliary device module according to claim 3, wherein a camera module is built with a car-mount type camera as said auxiliary device.
